(19) United States
(12) Patent Application Publication
(10) Pub. No.: US 2006/0128827 A1
(43) Pub. Date: Jun. 15, 2006

(54) Absorbent members comprising modified water absorbent resin for use in diapers

(75) Inventors: Makoto Matsumoto, Himeji-shi (JP); Yoshiro Mitsukami, Himeji-shi (JP); Hiroyuki Ikeuchi, Himeji-shi (JP); Kazushi Torii, Himeji-shi (JP); Taku Iwamura, Himeji-shi (JP); Andreas Flohr, Kronberg (DE); Torsten Lindner, Kronberg (DE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/297,965

(22) Filed: Dec. 8, 2005

(30) Foreign Application Priority Data
Dec. 10, 2004 (JP) 2004-359031
Aug. 22, 2005 (JP) 2005-240210

(51) Int. Cl. C08J 3/28

(52) U.S. Cl. 522/150

(57) ABSTRACT

An absorbent member for use in disposable diapers, wherein the absorbent member comprises a modified water absorbent resin. The modified water absorbent resin is made according to the method which comprises a) mixing a water absorbent resin and a water-soluble radical polymerization initiator or a heat-degradable radical polymerization initiator without addition of an ethylenically unsaturated monomer and b) irradiating the resultant mixture with active energy rays. The method is particularly capable of exalting the absorbency against pressure and the saline flow conductivity.

### FIELD OF THE INVENTION

An absorbent member for use in diapers, wherein the absorbent member comprises a modified water absorbent resin. The water absorbent resin is modified by irradiating active energy rays to the water absorbent resin mixed with a water-soluble radical polymerization initiator or a heat-degradable radical polymerization initiator without adding an ethylenically unsaturated monomer.

### BACKGROUND OF THE INVENTION

The water absorbent resin has been hitherto used as one component for hygienic materials such as sanitary cotton, disposable diaper, and absorbents for other kinds of body fluid. As concrete examples of the water absorbent resin, hydrolyzate of starch-acrylonitrile graft polymer, neutralized starch-acrylic acid graft polymer, saponified vinyl acetate-acrylic acid ester copolymer, hydrolyzate of acrylonitrile copolymer or acrylamide copolymer, and the product of crosslinkage thereof, and partially neutralized crosslinked acrylic acid may be cited. These water absorbent resins invariably possess an internal crosslinked structure and exhibit no solubility in water.

The characteristic properties which these water absorbent resins are expected to possess include high absorption capacity, perfect absorption speed, high gel strength, and fully satisfactory suction force necessary for sucking water from a medium, for example. Since the water absorbing properties are affected by crosslink density, they do not necessarily manifest positive correlations with one another as evinced by the fact that an increase in the crosslink density leads to an increase in the gel strength but a decrease in the amount of water absorbed. Particularly, the absorption capacity is in a contradictory relation with the absorption speed, the gel strength, and the suction force, for example. The water absorbent resin which has acquired an enhanced absorption capacity, therefore, possibly shuns uniform absorption of water and forms portions of partial aggregation of itself when the water absorbent resin particles contact with water and induces extreme deterioration of the absorption speed because the water is not diffused throughout the entire volumes of water absorbent resin particles.

For the purpose of relaxing this phenomenon and obtaining a water absorbent resin which has a high absorption capacity and a comparatively satisfactory absorption speed, a method for giving the water absorbent resin particles a surface coated with a surfactant or a nonvolatile hydrocarbon has been available. This method indeed exalts the dispersibility of the initially absorbed water but brings no sufficient effects in enhancing the absorption speed and the suction force of the individual resin particles.

As a means to produce a polyacrylic acid type polymer of high water absorbing property, a method which comprises causing an aqueous composition having a partial alkali metal salt of polyacrylic acid as a main component and having a low crosslink density to be heated in the presence of a water-soluble peroxide radical initiating agent thereby introducing a crosslink therein by radical crosslinkage has been proposed in U.S. Pat. No. 4,910,250. It is difficult to distribute uniformly internal crosslinks in the polymer and uneasy to adjust the crosslink density. Thus, a measure of preparing a polymer which contains water-soluble polyacrylic acid gel having low crosslink density and then heating the polymer together with a persulfate added thereto as a polymerization initiator is adopted. U.S. Pat. No. 4,910,250 claims to realize precise control of crosslink density by adjusting the amount of the initializing agent to be added and, owing to the uniform presence of crosslink in the polymer, acquire perfect water absorbing properties and obtain as well a water absorbent resin devoid of stickiness.

While the persulfate which is used in U.S. Pat. No. 4,910,250 mentioned above is decomposed by heat, it is decomposed by ultraviolet rays and generates radicals. Since the persulfate fulfills a function as a polymerization initiator, the aqueous solution of a water-soluble vinyl monomer, when exposed to radiation, undergoes polymerization and radical crosslinkage simultaneously and produces a hydrogel. A reaction system which forms an internal crosslink by adding a hydrophilic polymer component, a photo-polymerization initiator, and a crosslinking agent together and irradiating them with ultraviolet rays has been known.

Meanwhile, a method which gives a water absorbent resin a surface treatment with a crosslinking agent and imparts thereto a surface of a heightened crosslink density has been also known from U.S. Pat. No. 4,666,983 and U.S. Pat. No. 5,422,405, for example. Such water absorbent resins as cited in the preceding patent documents entail the presence of a reactive functional group on their surfaces. By effecting introduction of a crosslink between functional groups in consequence of the addition of a surface crosslinking agent capable of reacting with the functional groups, it is made possible to give to the water absorbent resin a surface of increased crosslink density and enable the water absorbent resin to acquire water absorbing properties perfect even under pressure.

Further, since the use of the surface crosslinking agent mentioned above requires the reaction for the formation of crosslinks to be performed at a high temperature for a long time and entails the problem of suffering persistence of the crosslinking agent in the unaltered state, a method which, by causing an aqueous solution containing a peroxide radical initiating agent to contact a resin and heating the resin, accomplishes introduction of crosslinks into polymer molecular chains in the neighborhood of the surface of the resin by virtue of decomposition of the radical initiating agent has been proposed in U.S. Pat. No. 4,783,510. In a working example of this method, a water absorbent resin exhibiting an exalted absorption capacity was obtained by effecting the heating with superheated steam at 130° C. for 6 minutes.

It is an objective of the present invention to introduce surface crosslinks into a water absorbent resin such that the water absorbent resin possesses a perfect balance between the absorption capacity and the absorption speed. This water absorbent resin is used in absorbent members used in diapers. Generally, this object requires a crosslinking agent possessing at least two functional groups capable of reacting with the functional group present in the surface of the water absorbent resin to act on the water absorbent resin. As concrete examples of the crosslinking agent of this quality, polyhydric alcohols, polyvalent glycidyl ethers, haloepoxy compounds, polyvalent aldehydes, polyvalent amines, and polyvalent metal salts may be cited. Since the crosslinking agent has low reactivity, the relevant reaction is required to be carried out at an elevated temperature and occasionally to be retained in a heated state for a long time. The reaction, therefore, demands copious amounts of energy and time.

The method of surface treatment as disclosed in U.S. Pat. No. 4,783,510 which uses a peroxide radical initiating agent as a crosslinking agent necessitates for efficient advance of the reaction a high reaction temperature and humidification serving the purpose of retaining the water necessary for the advance of the reaction. It, therefore, stands in need of further exaltation of the efficiency of production.

This invention is aimed at providing absorbent members comprising water absorbent resins made according to a method for the production of a water absorbent resin which is so modified as to excel in the efficiency of production and in such properties as absorbency against pressure, absorption speed, gel strength, and permeability of liquid.

### SUMMARY OF THE INVENTION

The invention refers to an absorbent member for use in disposable diapers wherein the absorbent member comprises a modified water absorbent resin produced according to the method, which comprises mixing a water absorbent resin and a water-soluble radical polymerization initiator without addition of an ethylenically unsaturated monomer and irradiating the resultant mixture with active energy rays.

Further, the invention refers to an absorbent member for use in disposable diapers, wherein the absorbent member comprises a powdery modified water absorbent resin to be obtained by polymerizing monomer components including as a main component acrylic acid (salt), characterized by having saline flow conductivity of not less than 40 (10⁻⁷·cm³·s·g⁻¹), a solid content of not more than 95%, and a residual monomer content of not more than 150 ppm.

The invention also refers to an absorbent member for use in disposable diapers wherein the absorbent member comprises a modified water absorbent resin produced according to the method, which comprises (a) mixing a water absorbent resin and a persulfate without addition of an ethylenically unsaturated monomer, (b) adding a mixing aid other than water at the same time as or prior to the step (a), and (c) irradiating the resultant mixture with active energy rays.

In a further embodiment, the invention refers to an absorbent member for use in disposable diapers wherein the absorbent member comprises a modified water absorbent resin produced according to the method, which comprises mixing a water absorbent resin and a persulfate without addition of an ethylenically unsaturated monomer, and irradiating the resultant mixture with active energy rays, wherein said water absorbent resin has an acid group and a neutralization ratio (mol % of the neutralized acid group in the whole acid group) in the range of 50-75 mol %.

The invention also refers to an absorbent member for use in disposable diapers wherein the absorbent member comprises a modified water absorbent resin produced according to the method, which comprises (a) mixing a water absorbent resin and a persulfate without addition of an ethylenically unsaturated monomer, (b) adding a mixing aid other than water at the same time as or prior to the step (a), and (c) irradiating the resultant mixture with active energy rays, wherein said water absorbent resin has an acid group and a neutralization ratio (mol % of the neutralized acid group in the whole acid group) in the range of 50-75 mol %.

### BRIEF DESCRIPTION OF THE DRAWINGS

While the specification concludes with claims pointing out and distinctly claiming the present invention, it is believed the same will be better understood by the following drawings taken in conjunction with the accompanying specification wherein like components are given the same reference number.

FIG. 1 is a schematic diagram of a measuring device to be used in determining the saline flow conductivity (SFC).

### DETAILED DESCRIPTION OF THE INVENTION

A detailed study made of the method for producing a water absorbent resin of modified surface reveals that when a persulfate which has heretofore been used as a (heat-degradable) radical polymerization initiator is irradiated with active energy rays, the persulfate generates radicals and easily enables a water absorbent resin to form a crosslinked structure on the surface thereof. Moreover, this method is found to effect the introduction of the surface crosslink without requiring use of a surface crosslinking agent which has been an essential component for the conventional method and allow the produced water absorbent resin to excel in the balance of water absorbing properties.

Heretofore, the surface crosslinkage has required a treatment at a high temperature in the range of 100-300° C., depending on the kind of a surface crosslinking agent to be incorporated in the relevant composition. The method used to make water absorbent resins for use in absorbent members of this invention is capable of effecting introduction of a surface crosslink simply by irradiation with active energy rays without requiring use of a surface crosslinking agent. Thus, the water absorbent resin can be modified without being exposed to a high temperature and can be prevented from succumbing to thermal degradation during the course of modification.

Moreover, since the persulfate is soluble in water, it can be dissolved in an aqueous solution and mixed with the water absorbent resin and consequently enabled to ensure formation of a uniform surface crosslink on the resin. As a result, the water absorbent resin which has been modified veritably excels in such characteristic properties as absorption capacity, absorption speed, gel strength, and suction force which the water absorbent resin is expected to possess.

The method for the production of a modified water absorbent resin used in absorbent members of this invention effects the surface crosslinkage by irradiation with the active energy rays. It is, therefore, capable of modifying the water absorbent resin in a brief space of time as compared with the conventional method.

The first aspect of this invention is directed toward a method for the production of a modified water absorbent resin used in absorbent members of this invention, wherein the method comprises mixing a water absorbent resin and a water-soluble radical polymerization initiator without addition of an ethylenically unsaturated monomer and irradiating the resultant mixture with an active energy rays.

The second aspect of this invention is directed toward a method for the production of a modified water absorbent resin, which comprises mixing a water absorbent resin and a heat-degradable radical polymerization initiator without addition of an ethylenically unsaturated monomer and irradiating the resultant mixture with an active energy rays.

Now, the method for the production of the modified water absorbent resin according to this invention will be described in detail below.

(a) Water Absorbent Resin

The water absorbent resin which can be used in absorbent members of this invention is a crosslinked polymer having ability to swell in water and insoluble in water and, therefore, being capable of forming a hydrogel. The term “ability to swell in water” as used in this invention refers to the free swelling capacity of a given sample in an aqueous 0.9 wt. % sodium chloride solution (physiological saline), i.e. the ability of the sample to absorb the physiological saline essentially not lower than 2 g/g and preferably in the range of 5-100 g/g or in the range of 10-60 g/g. The term “insoluble in water” refers to the uncrosslinked extractable polymer (extractable polymer) in the water absorbent resin, which should be in the range of 0-50 wt. %, or not more than 25 wt. %, or not more than 15 wt. %, or not more than 10 wt. %. The numerical values of the free swelling capacity and the extractable polymer are to be those which are found by the methods of determination specified in the working example cited herein below. The term “modification” refers to all physical or chemical actions performed on the water absorbent resin with the object of enabling the water absorbent resin to acquire surface crosslinkage, form pores therein, and enjoy endowment of hydrophilic property or hydrophobic property, for example.

The water absorbent resin which can be used in absorbent members of this invention does not need to be particularly restricted but is only required to be capable of being obtained by polymerizing a monomer component essentially containing an ethylenically unsaturated monomer by means of any of the known methods.

The ethylenically unsaturated monomer is not particularly restricted but is preferred to be a monomer possessing an unsaturated double bond at the terminal thereof. As concrete examples of the monomer of this description, anionic monomers such as (meth)acrylic acid, 2-(meth)acryloyl ethane sulfonic acid, 2-(meth)acryloyl propane sulfonic acid, 2-(meth)acrylamide-2-methyl propane sulfonic acid, vinyl sulfonic acid, and styrene sulfonic acid and salts thereof; nonionic hydrophilic group-containing monomers such as (meth)acrylamide, N-substituted (meth)acrylamide, 2-hydroxyethyl (meth)acrylate, and 2-hydroxypropyl(meth)acrylate; and amino group-containing unsaturated monomers such as N,N-dimethylaminoethyl (meth)acrylate, N,N-diethylaminoethyl (meth)acrylate, N,N-diethylaminopropyl (meth)acrylate, and N,N-dimethylaminopropyl (meth)acrylamide and quaternized products thereof may be cited. These monomers may be used either singly or in the form of a mixture of two or more members. Among monomers enumerated above, (meth)acrylic acid, 2-(meth)acryloyl ethane sulfonic acid, 2-(meth)acrylamide-2-methylpropane sulfonic acid, and salts thereof, N,N-dimethylaminoethyl(meth)acrylate and quaternized N,N-dimethylaminoethyl (meth)acrylate, and (meth)acrylamide prove preferable and acrylic acid and/or a salt thereof prove particularly preferable.

When an acrylic acid salt is used as the monomer, the monovalent salt of acrylic acid selected from among alkali metal salts, ammonium salt, and amine salt of acrylic acid proves favorable from the viewpoint of the ability of the water absorbent resin to absorb water. The alkali metal salt of acrylic acid and/or the acrylic acid salt may be selected from among sodium salt, lithium salt, and potassium salt prove favorable.

In the production of the water absorbent resin, other monomer components than the monomers enumerated above may be used in amounts incapable of impairing the effect of this invention. As concrete examples of such other monomer components, hydrophobic monomers such as aromatic ethylenically unsaturated monomers having carbon numbers in the range of 8-30, aliphatic ethylenically unsaturated monomers having carbon numbers in the range of 2-20, alicyclic ethylenically unsaturated monomers having carbon numbers in the range of 5-15, and alkyl esters of (meth)acrylic acid containing alkyl groups having carbon numbers in the range of 4-50 may be cited. The proportion of such a hydrophobic monomer is generally in the range of 0-20 weight parts based on 100 weight parts of the ethylenically unsaturated monomer mentioned above. If the proportion of the hydrophobic monomer exceeds 20 weight parts, the overage will possibly result in deteriorating the water absorbing property of the produced water absorbent resin.

The water absorbent resin which is used in absorbent members of this invention is insolubilized by the formation of an internal crosslink. This internal crosslink may be the product obtained by the self-crosslinkage using no crosslinking agent. It may be formed by using an internal crosslinking agent possessing not less than two polymerizable unsaturated group and/or not less than two reactive functional groups in the molecular unit.

The internal crosslinking agent of this description does not need to be particularly restricted. As concrete examples of the inner crosslinking agent, N,N′-methylenebis(meth)acrylamide, N-methylol (meth)acrylamide, glycidyl (meth)acrylate, (poly)ethylene glycol di(meth)acrylate, (poly)propylene glycol di(meth)acrylate, glycerin tri(meth)acrylate, glycerin acrylate methacrylate, polyvalent metal salts of (meth)acrylic acid, trimethylol propane tri(meth)acrylate, triallyl amine, triallyl cyanurate, triallyl isocyanurate, triallyl phosphate, ethylene glycol diglycidyl ether, (poly)glycerol glycidyl ether, and polyethylene glycol diglycidyl ether may be cited. These internal crosslinking agents may be used in the form of a mixture of two or more members.

The amount of the internal crosslinking agent to be used may be in the range of 0.0001-1 mol %, or in the range of 0.001-0.5 mol %, or in the range of 0.005-0.2 mol %. If this amount falls short of 0.0001 mol %, the shortage will result in preventing the internal crosslinking agent from being introduced into the resin. Conversely, if the amount exceeds 1 mol %, the excess will possibly result in unduly heightening the gel strength of the water absorbent resin and lowering the absorption capacity. For the introduction of the crosslinked structure into the interior of the polymer by the use of the internal crosslinking agent, it suffices to add the internal crosslinking agent into the reaction system before, during, or after the polymerization of the monomer or after neutralization of the produced polymer.

For the purpose of producing the water absorbent resin, it suffices to polymerize the monomer components including the monomer mentioned above and the internal crosslinking agent in an aqueous solution thereof. The polymerization initiators which can be used in this case are water-soluble radical polymerization initiators including persulfates such as potassium persulfate, ammonium persulfate, and sodium persulfate; potassium peracetate, sodium peracetate, potassium percarbonate, sodium percarbonaate, and t-butyl hydroperoxide; hydrogen peroxide; azo compounds such as 2,2′-azobis(2-amidinopropane)-dihydrochloride and photopolymerization initiators including 2-hydroxy-2-methyl-1phenyl-propan-1-on, for example. The water-soluble radical polymerization initiators mentioned above may be combined with a reducing agent such as a sulfite, L-ascorbic acid, or a ferric salt so as to be used as redox type initiators.

The concentration of the monomer in the aqueous monomer solution mentioned above does not need to be particularly restricted but may fall in the range of 15-90 wt. % or in the range of 35-80 wt. %. If this concentration falls short of 15 wt. %, the shortage will be at a disadvantage in necessitating consumption of heat and time for drying because the resultant hydrogel has an unduly large water content.

The method to be adopted for the polymerization is not particularly restricted but may be selected from among the known methods such as solution polymerization, reversed-phase suspension polymerization, precipitation polymerization, and bulk polymerization. Among these methods, the aqueous solution polymerization which comprises dissolving a monomer in an aqueous solution and polymerizing it in the aqueous solution, and the reversed phase suspension polymerization prove particularly advantageous on account of the ease of control of a polymerization reaction and the performance of a produced water absorbent resin.

In initiating the aforementioned polymerization, the polymerization initiator mentioned above is used to effect this initiation. Besides the polymerization initiator mentioned above, such active energy rays as ultraviolet rays, electron radiation, and y rays may be used either singly or in combination with a polymerization initiator. Though the temperature in initiating the polymerization depends on the kind of polymerization initiator to be used, it may fall in the range of 15-130° C. or in the range of 20-120° C. If the temperature in initiating the polymerization deviates from the range mentioned above, the deviation will be at a disadvantage in increasing the residual monomer in the produced water absorbent resin and suffering the self crosslinking reaction to proceed excessively and consequently deteriorating the water absorbing property of the water absorbent resin.

The term “reversed phase suspension polymerization” refers to a method of polymerization performed on an aqueous monomer solution suspended in a hydrophobic organic solvent. It is disclosed in U.S. Pat. No. 4,093,776, No. 4,367,323, No. 4,446,261, No. 4,683,274, and No. 5,244,735, for example. The term “aqueous solution polymerization” refers to a method for polymerizing an aqueous monomer solution without using a dispersing solvent. It is disclosed in U.S. Pat. No. 4,625,001, U.S. Pat. No. 4,873,299, U.S. Pat. No. 4,286,082, U.S. Pat. No. 4,973,632, U.S. Pat. No. 4,985,518, U.S. Pat. No. 5,124,416, U.S. Pat. No. 5,250,640, U.S. Pat. No. 5,264,495, U.S. Pat. No. 5,145,906, and U.S. Pat. No. 5,380,808 and European Patent No. 0,811,636, U.S. Pat. No. 0,955,086, and U.S. Pat. No. 0,922,717, for example. The monomers and the initiators which are cited by way of illustration in these methods of polymerization can be applied to this invention.

The aqueous solution polymerization may be performed by polymerizing partially neutralized acrylic acid or polymerizing them in the acid form and subsequently neutralizing the resultant polymer with such an alkali compound as sodium hydroxide or sodium carbonate. Accordingly, the water absorbent resin to be used in this invention may have an acid group and a specific neutralization ratio (mol % of the neutralized acid group in the whole acid group). In this case, the neutralization ratio of the produced water absorbent resin (the mol % of the neutralized acid group in the whole acid group) falls in the range of 25-100 mol % or in the range of 50-90 mol %, or in the range of 50-75 mol %, or even in the range of 60-70 mol %. Therefore, the preferable embodiment according to this invention is to provide a method for the production of a modified water absorbent resin, which comprises a) mixing a water absorbent resin and a water-soluble radical polymerization initiator without addition of an ethylenically unsaturated monomer and b) irradiating the resultant mixture with active energy rays, wherein said water absorbent resin has an acid group and a neutralization ratio (mol % of the neutralized acid group in the whole acid group) in the range of 50-75 mol %.

The result of the polymerization is generally a hydrogel-like crosslinked polymer. While this invention permits this hydrogel-like crosslinked polymer in its unaltered form as a water absorbent resin, it prefers the polymer to be dried to the water content (%) [100−(solid content) (%)] which will be specifically described herein below.

Incidentally, this invention modifies the water absorbent resin by the use of a water-soluble radical polymerization initiator or a heat-degradable radical polymerization initiator (in the present specification, referred collectively to as “radical polymerization initiator”) and active energy rays as described specifically herein below. This modification results from the action of the radicals generated from the polymerization initiator on the main chain of the polymer. This modification, therefore, does not need to be limited to the water absorbent resin which is obtained by polymerizing the water-soluble ethylenically unsaturated monomer described above but may be effected on such water absorbent resins as crosslinked polyvinyl alcohol, crosslinked polyethylene oxide, crosslinked polyaspartic acid, and crosslinked carboxymethyl cellulose, for example.

The water absorbent resin which is used in absorbent members of this invention may be a powdery water absorbent resin which is obtained by polymerizing a monomer having acrylic acid (salt) particularly as its main component. The hydrogel-like crosslinked polymer which is obtained by polymerization may be dried and subsequently pulverized to a water absorbent resin. The drying may be effected by using a drier such as a hot air drier at a temperature in the range of 100-220° C. or in the range of 120-200° C.

For use in the pulverization, among shear primary crushers, impact shredders, and high speed rotary grinders included in the names of the powdering machines classified in Table 1.10 of Particle Technology Handbook (first edition, compiled by Particle Technology Association), the powdering machines which possess at least one of the powdering mechanisms such as cutting, shearing, striking, and rubbing can be adopted particularly favorably.

Among the powdering machines which answer the foregoing description, the powdering machines which have cutting and shearing as main mechanisms can be used particularly advantageously. A roll mill (roll rotary type) powdering machine may be cited as a preferred example.

The water absorbent resin which is used in absorbent members of this invention is preferred to be in a powdery form. It may be a powdery water absorbent resin which contains particles of a diameter in the range of 150-850 μm (as defined by sieve classification) in a proportion falling in the range of 90-100% by weight or in the range of 95-100% by weight. When the modified water absorbent resin having a particle diameter exceeding 850 μm is used in disposable diapers, for example, it imparts a disagreeable feel to the user's skin and possibly inflicts a rupture on the top sheet of a diaper. If the particles of a diameter smaller than 150 μm in a proportion exceeding 10% by weight based on weight of the water absorbent resin, the fine particles will scatter and clog the texture while in use and will possibly degrade the water absorbing property of the modified water absorbent resin. The weight average particle diameter of the water absorbent resin falls in the range of 10-1,000 μm or in the range of 200-600 μm. If the weight average particle diameter falls short of 10 μm, the shortage will possibly prove unfavorable in terms of safety and health. Conversely, if it exceeds 1,000 μm, the excess will possibly result in preventing the water absorbent resin from being used in disposable diapers, for example. The particle diameter mentioned above is the values determined by the method for determination of particle size distribution described in the working example cited herein below.

In addition or alternatively, the water absorbent resin to be used in absorbent members of this invention may be obtained by producing a water absorbent resin precursor having a low neutralization ratio, and mixing the water absorbent resin precursor with a base. Multifunctional surface-treatment agents have been conventionally used for the surface-treatment (surface crosslinkage). The multifunctional surface-treatment agents have such properties that they react with carboxyl groups (—COOH) in a water absorbent resin but do not react with the salt thereof (for example, —COONa). Accordingly, uniform crosslinkage can be attained by preparing an ethylenically unsaturated monomer mixture (for example, a mixture of acrylic acid with sodium acrylate) in which —COOH/—COONa ratio has been adjusted within a suitable range in advance, polymerizing the resultant mixture to produce a water absorbent resin having the —COOH and —COONa groups uniformly distributed therein, and subjecting the resultant water absorbent resin to the surface crosslinkage with a multifunctional surface-treatment agent. On the other hand, when a water absorbent resin is obtained by polymerizing a monomer mixture including an acid type ethylenically unsaturated monomer like acrylic acid as a main component, and then neutralizing the resultant polymer with an alkali compound such as sodium hydroxide and sodium carbonate, the resultant water absorbent resin has a small extractable polymer content and high gel strength. It, however, when subjected to the surface crosslinkage with a multifunctional surface-treatment agent, has deteriorated water absorbency, because the —COOH and —COONa groups are not uniformly distributed in the water absorbent resin. Accordingly, the water absorbent resin to be produced by the latter method is not desirably subjected to such a conventional surface crosslinkage with a multifunctional surface-treatment agent. Conversely, according to the method used to make a water absorbent resin for use in the absorbent members of this invention, since a water-soluble radical polymerization initiator or a heat-degradable radical polymerization initiator induces crosslinkage by extracting a hydrogen in a main chain to form a radical and using the radical for coupling, but not by reacting with —COOH, the cross-linking reaction is not affected by whether or not the —COOH groups are uniformly distributed in the water absorbent resin. As a result, according to the method used to make a water absorbent resin for use in the absorbent members of this invention, a water absorbent resin which is obtained by polymerizing a monomer or a monomer mixture including as a main component an acid type ethylenically unsaturated monomer like acrylic acid to obtain a water absorbent resin precursor having a low neutralization ratio, and then neutralizing the water absorbent resin precursor with an alkali compound such as sodium hydroxide and sodium carbonate can be modified, and the resultant modified water absorbent resin to be obtained by this method can manifest high gel strength and excellent water absorbency.

In this invention, the expression “water absorbent resin precursor having a low neutralization ratio” is referred to as a water absorbent resin precursor having a low neutralization ratio (mol % of the neutralized acid group in the whole acid group) or having no neutralized acid groups (i.e., the neutralization ratio is zero), and typically referred to as a water absorbent resin precursor having a neutralization ratio (mol % of the neutralized acid group in the whole acid group) in the approximate range of 0 to 50 mol %, or in the approximate range of 0 to 20 mol %. Such a water absorbent resin precursor having a low neutralization ratio can be obtained by the same method as mentioned above by using a monomer mixture including as a main component an acid group-containing monomer like acrylic acid wherein neutralization ratio may be adjusted within the above range. Thus the detailed explanation of the precursor will be omitted.

The water content of the water absorbent resin to be used in the method for production of a modified water absorbent resin contemplated by this invention for use in absorbent members has no particular restriction so long as the water absorbent resin possesses fluidity. The water absorbent resin after being dried at 180° C. for three hours possesses a water content falling in the range of 0-20 wt. %, or in the range of 0-10 wt. %, or in the range of 0-5 wt. %.

The water absorbent resin to be used in absorbent members of this invention is not limited to the product of the method described above but may be the product obtained by some other method. While the water absorbent resin which is obtained by the method described above is a water absorbent resin having undergone no surface crosslinkage, for use in the method for producing a modified water absorbent resin of this invention, the water absorbent resin which has undergone surface crosslinkage in advance with a polyhydric alcohol, a polyvalent epoxy compound, an alkylene carbonate, or an oxazolidone compound can be adopted.

(b) Water-Soluble Radical Polymerization Initiator

The method for the production of a modified water absorbent resin for use in absorbent members of the present invention comprises mixing a water-soluble radical polymerization initiator and the aforementioned water absorbent resin without addition of an ethylenically unsaturated monomer. Hitherto, the surface crosslinkage of a water absorbent resin has been generally effected by incorporating a surface crosslinking agent. The incorporation of the surface crosslinking agent results in strongly binding chemically the functional groups present on the surface of resin with the surface crosslinking agent and consequently introducing a stable surface crosslink structure into the resin surface. Then, by properly selecting the chain length of the surface crosslinking agent, it is made possible to adjust easily the distance between crosslinks. By adjusting the amount of the surface crosslinking agent to be incorporated, it is made possible to control the crosslink density. This invention, however, has been demonstrated to modify the water absorbent resin, specifically to introduce a crosslink structure to the surface of the water absorbent resin by merely using a water-soluble radical polymerization initiator without requiring the incorporation of the surface crosslinking agent mentioned above. This invention uses the expression “without addition of an ethylenically unsaturated monomer” with the object of preventing the water-soluble radical polymerization initiator from reacting with the ethylenically unsaturated monomer to avoid the consumption of the water-soluble radical polymerization initiator that is activated by the irradiation with active energy rays prior to the action on the surface of the absorbent resin.

In this invention, though the reason for the formation of the surface crosslinkage by the water-soluble radical polymerization initiator and the active energy rays is not clear, the fact that the crosslink structure is formed even in the absence of the crosslinking compound is thought to justify an inference that the water-soluble radical polymerization initiator activated by the exposure to the active energy rays acts on a several portions of the main chain or side chain existing on the surface of the water absorbent resin and causes both of them to be bound together by some action or other. This action, for example, may be ascribed to the reaction which extracts hydrogen from the main chain of the water absorbent resin and activates carbon atoms, causes these carbon atoms existing adjacently to be mutually bound, and eventually forms crosslink structures randomly.

This invention particularly designates “a water-soluble radical polymerization initiator” because this initiator can be easily dispersed uniformly on the surface of the water absorbent resin which excels in hydrophilic property and water absorbing property. Thus, it is made possible to produce a water absorbent resin which excels in the water absorbing property.

The water-soluble radical polymerization initiator to be used in this invention possesses solubility of not less than 1 wt. %, or not less than 5 wt. %, or not less than 10 wt. % in water (25°). As concrete examples of the water-soluble radical polymerization initiator answering this description, persulfates such as ammonium persulfate, sodium persulfate, and potassium persulfate; hydrogen peroxide; and water-soluble azo compounds such as 2,2′-azobis-2-amidinopropane dihydrochloride and 2,2′-azobis[2-2(-imidazolin-2-yl) propane] dihydrochloride may be cited. The use of a persulfate particularly among them proves favorable in respect that the modified water absorbent resin excels in the absorbency of physiological saline against pressure (in this specification, referred simply to as “absorbency against pressure”), the saline flow conductivity, and the free swelling capacity of physiological saline (in this specification, referred simply to as “free swelling capacity”).

The amount of the water-soluble radical polymerization initiator may fall in the range of 0.01-20 weight parts, or in the range of 0.1-15 weight parts, or in the range of 1-10 weight parts based on 100 weight parts of the water absorbent resin. If the amount of the water-soluble radical polymerization initiator to be mixed falls short of 0.01 weight part, the shortage will possibly result in preventing the water absorbent resin from being modified even by the exposure to the active energy rays. Conversely, if the amount of the water-soluble radical polymerization initiator to be mixed exceeds 20 weight parts, the overage will possibly result in deteriorating the water absorbing property of the modified water absorbent resin.

This invention, by essentially using the water-soluble radical polymerization initiator, is enabled to accomplish the production of the water absorbent resin possessing excellent properties as compared with the case of using absolutely no water-soluble radical polymerization initiator, such as when an oil-soluble radical polymerization initiator, particularly an oil-soluble photopolymerization initiator, alone is used. Incidentally, the term “oil-soluble photopolymerization initiator” as used herein means a compound which exhibits solubility of less than 1 wt. % to water, for example.

While this invention essentially uses a water-soluble radical polymerization initiator selected from among persulfates, hydrogen peroxide, and water-soluble azo compounds, it may use additionally an initiator other than the water-soluble radical polymerization initiator. As concrete examples of the other polymerization initiator which can be additionally used as described above, photopolymerization initiators such as oil-soluble benzoin derivatives, benzyl derivatives, and acetophenone derivatives and oil-soluble organic peroxides such as oil-soluble ketone peroxide, peroxyketal, hydroperoxide, dialkyl peroxide, peroxy esters, and peroxycarbonate may be cited. These photopolymerization initiators may be commercially available products such as, for example, the products of Ciba Specialty Chemicals sold under the trademark designations of Irgacure 184 (hydroxycyclohexyl-phenyl ketone) and Irgacure 2959 (1-[4-(2-hydroxyethoxy)-phenyl]-2-hydroxy-2-methyl-1-propan-1-on).

When this invention necessitates additional use of other initiator, the amount of the initiator to be used falls in the range of 0-20 weight parts, or in the range of 0-15 weight parts, or even in the range of 0-10 weight parts, based on 100 weight parts of the water absorbent resin. This rate of use corresponds to a smaller amount than the water-soluble radical polymerization initiator such as, for example, not more than 1/2, further not more than 1/10, and particularly not more than 1/50 of the weight ratio of the water-soluble radical polymerization initiator.

(c) Heat-Degadable Radical Polymerization Initiator

According to this invention, it has been found that among heat-degradable radical polymerization initiators, a radical polymerization initiator having a specific 10 hour half-life decomposition temperature can manifest effects similar to those achieved with the water-soluble radical polymerization initiator described above. As used herein, the term “heat-degradable radical polymerization initiator” refers to a compound which generates a radical by heating. A heat-degradable radical polymerization initiator having 10 hour half-life decomposition temperature in the range of 0 to 120° C., or 20 to 100° C., may be used in this invention. Considering the temperature during irradiation with active energy rays, a heat-degradable radical polymerization initiator having 10 hour half-life decomposition temperature in the range of 40 to 80° C. is particularly preferably used in this invention. If the lower limit of 10 hour half-life decomposition temperature is less than 0° C., the heat-degradable radical polymerization initiator is too unstable during the storage. Conversely, if the upper limit thereof exceeds 120° C., the chemical stability of the heat-degradable radical polymerization initiator is likely too high and results in lowered reactivity.

The heat-degradable radical polymerization initiator has the advantage of being relatively inexpensive. Further, the process and devices for the production thereof can be simplified because strict light-shielding is not always required, as compared to a compound which has been commercially available as a photo-degradable radical polymerization initiator. As typical examples of the heat-degradable radical polymerization initiator, persulfates such as sodium persulfate, ammonium persufalte, and potassium persulfate; percarbonates such as sodium percarbonate; peracetates such as peracetic acid, and sodium peracetate; hydrogen peroxide; and azo compounds such as 2,2′-azobis (2-amidinopropane) dihydrochloride, 2,2′-azobis [2-2(-imidazolin-2-yl) propane] dihydrochloride, and 2,2′-azobis (2-methylpropionitrile) may be cited. Among the heat-degradable radical polymerization initiators cited above, persulfates including sodium persulfate, ammonium persulfate, and potassium persulfate, and azo compounds including 2,2′-azobis (2-amidinopropane) dihydrochloride, 2,2′-azobis [2-2(-imidazolin-2-yl) propane] dihydrochloride, and 2,2′-azobis (2-methylpropionitrile) which have 10 hour half-life decomposition temperature in the range of 40 to 80° C. may be used. Particularly, persulfates may be used in respect of excellent absorbency of physiological saline against pressure, saline flow conductivity, and free swelling capacity.

The method for the production of a modified water absorbent resin for use in the absorbent members of the present invention comprises mixing a heat-degradable radical polymerization initiator and the water absorbent resin without addition of an ethylenically unsaturated monomer. Hitherto, the surface crosslinkage of a water absorbent resin has been generally effected by incorporating a surface crosslinking agent. The incorporation of the surface crosslinking agent results in strong chemical bonding between the surface crosslinking agent and the functional groups present on the surface of resin and consequently introduces stable surface crosslink structure into the resin surface. Then, by properly selecting the chain length of the surface crosslinking agent, it is made possible to easily adjust the distance between crosslinks. By adjusting the amount of the surface crosslinking agent to be incorporated, the crosslink density can be controlled. This invention, however, has demonstrated the modification of the water absorbent resin, specifically the introduction of a crosslink structure to the surface of the water absorbent resin, by merely using a heat-degradable radical polymerization initiator without requiring the incorporation of the surface crosslinking agent mentioned above. This invention uses the expression “without addition of an ethylenically unsaturated monomer” with the object of preventing the heat-degradable radical polymerization initiator from reacting with the ethylenically unsaturated monomer to avoid the consumption of the heat-degradable radical polymerization initiator that is activated by the irradiation with active energy rays prior to the action on the surface of the absorbent resin.

In this invention, thought the reason for the formation of the surface crosslinkage by the heat-degradable radical polymerization initiator and the active energy rays is not clear, the fact that the crosslink structure is formed even in the absence of the crosslinking compound is believed to be due to the heat-degradable radical polymerization initiator being activated by the exposure to the active energy rays, which act on several portions of the main chain or side chain existing on the surface of the water absorbent resin and causes both of them to be bound together by some action or other. This action, for example, may be ascribed to the reaction which extracts hydrogen from the main chain of the water absorbent resin and activates carbon atoms, causes these carbon atoms existing adjacently to be mutually bound, and eventually forms crosslink structures randomly.

By adding to a water absorbent resin a polymerization initiator having a specific 10 hour half-life decomposition temperature and then irradiating the resultant mixture with active energy rays, the surface crosslinkage can be carried out at a low temperature for a short period of time and the resultant modified water absorbent resin can manifest high gel strength and excellent water-absorbing properties. The heat-degradable radical polymerization initiator for use in this invention may be either oil-soluble or water-soluble. The composition rate of an oil-soluble heat-degradable radical polymerization initiator is less sensitive to pH and ion strength as compared to that of a water-soluble heat-degradable radical polymerization initiator. However, a water-soluble heat-degradable radical polymerization initiator may be more preferably used in respect of its permeability to a water absorbent resin because the water absorbent resin is hydrophilic.

The amount of the heat-degradable radical polymerization initiator may be in the range of 0.01-20 weight parts, or may be in the range of 0.1-15 weight parts, or even in the range of 1-10 weight parts, based on 100 weight parts of the water absorbent resin. If the amount of the heat-degradable radical polymerization initiator to be mixed is below 0.01 weight part, the shortage will possibly result in preventing the water absorbent resin from being modified even by the exposure to the active energy rays. Conversely, if the amount of the heat-degradable radical polymerization initiator to be mixed exceeds 20 with parts, the overage will possibly result in deterioration of the water absorbing property of the modified water absorbent resin.

According to the second aspect of this invention, a heat-degradable radical polymerization initiator including persulfate, hydrogen peroxide and an azo compound, may be used. In this case, two or more persulfates having different counterions can be used in combination, as well as a persulfate can be used solely. Further, an initiator other than the heat-degradable radical polymerization initiator can be additionally used. As typical examples of the other initiator used herein, photo polymerization initiators such as oil-soluble benzoin derivatives, benzyl derivatives, and acetophenone derivatives may be cited. A commercially available photo polymerization initiator may be used and such commercially available photo polymerization initiators include products of Ciba Specialty Chemicals sold under the trademark designation of Irgacure 184 (hydroxycyclohexyl-phenyl ketone) and Irgacure 2959 (1-[4-(2-hydroxyethoxy)-phenyl]-2-hydroxy-2-methyl-1-pro pan-1-on), for example.

If other initiators are used additionally, the amount of the initiator to be used should be in the range of 0-20 parts, or in the range of 0-15 parts, or even in the range of 0-10 parts, based on 100 weight parts of the water absorbent resin. This amount corresponds to a smaller amount than the heat-degradable radical polymerization initiator such as, for example, not more than 1/2, further not more than 1/10, and particularly not more than 1/50 of the weight ratio of the heat-degradable radical polymerization initiator.

(d) Mixing of Water Absorbent Resin and Water-Soluble Radical Polymerization Initiator or Heat-Degradable Radical Polymerization Initiator

In the present specification, the phrase “water-soluble radical polymerization initiator or heat-degradable radical polymerization initiator” may be referred simply to as “radical polymerization initiator”.

While the mixing of the radical polymerization initiator and the water absorbent resin mentioned above may be accomplished by mixing the radical polymerization initiator to be mixed in its unmodified form with the water absorbent resin, it may be performed by dissolving the initiator in an aqueous solution and then mixing the resultant aqueous solution with the water absorbent resin. Since the water absorbent resin is capable of absorbing water, the procedure of dissolving the radical polymerization initiator in the aqueous solution and supplying the resultant aqueous solution enables the radical polymerization initiator to be uniformly dispersed on the surface of the water absorbent resin and uniformly mixed with the water absorbent resin. The aqueous solution may contain, besides water, some other solvent in an amount incapable of impairing the solubility of the radical polymerization initiator.

The amount of the aqueous solution to be used falls in the range of 1-20 weight parts based on 100 weight parts (as reduced to 100 wt. % of the solid content) of the water absorbent resin. If the amount of the aqueous solution falls short of 1 weight part, the shortage will possibly result in preventing the surface crosslinkage from being sufficiently effected even when the radical polymerization initiator is exposed to the active energy rays. Conversely, if the amount of the aqueous solution exceeds 20 weight parts, the overage will be at a disadvantage in necessitating consumption of unduly large amount of energy at the drying step which follows the exposure to the active energy rays. The overage will possibly induce the water absorbent resin to decompose. The aqueous solution can be used for the purpose of dissolving the radical polymerization initiator. After the radical polymerization initiator and the water absorbent resin are mixed together, the resultant mixture may be mixed with water or the aqueous solution at a ratio falling in the range mentioned above. Likewise, the crosslinked hydrogel obtained by polymerizing the monomer components and then dried to a water content in the range of 0-20 wt. % can be directly mixed with the radical polymerization initiator.

For the purpose of exalting the mixing property of the aqueous solution with the water absorbent resin, a mixing aid other than water may be added. Although the time of adding a mixing aid is not particularly limited, the mixing aid may be added at the same time as or prior to the step a) mixing a water absorbent resin with a radical polymerization initiator. Therefore, the preferable embodiment of this invention is to provide a method for the production of a modified water absorbent resin, which comprises a) mixing a water absorbent resin and a persulfate without addition of an ethylenically unsaturated monomer, b) adding a mixing aid other than water at the same time as or prior to the step a), and c) irradiating the resultant mixture with active energy rays. Further, the more preferable embodiment of this invention is to provide a method for the production of a modified water absorbent resin, which comprises a) mixing a water absorbent resin and a persulfate without addition of an ethylenically unsaturated monomer, b) adding a mixing aid other than water at the same time as or prior to the step a), and c) irradiating the resultant mixture with active energy rays, wherein said water absorbent resin has an acid group and a neutralization ratio (mol % of the neutralized acid group in the whole acid group) in the range of 50-75 mol %.

The mixing aid other than water is not particularly limited, as long as it is a water-soluble or water-dispersible compound except an ethylenically unsaturated monomer or a radical polymerization initiator, and it can repress the agglomeration of the water absorbent resin with water and improve the mixing of the aqueous solution with the water absorbent resin. The mixing aid may be a water-soluble or water-dispersible compound. As such a water-soluble or water-dispersible compound, surfactants, water-soluble polymers, hydrophilic organic solvents, water-soluble inorganic compounds, inorganic acids, inorganic acid salts, organic acids, and organic acid salts can be typically used. In this specification, the term “water-soluble compound” is referred to as a compound having solubility in 100 g of water at room temperature of not less than 1 g, or not less than 10 g. Since the addition of the mixing aid can repress the agglomeration of the water absorbent resin with water, and induce the uniform mixing of the aqueous solution with the water absorbent resin, the active energy rays, when irradiated in the subsequent step, can be irradiated equally and evenly to the water absorbent resin and thus the uniform surface crosslinkage of the entire water absorbent resin can be attained.

The form of the mixing aid to be used is not particularly limited, and it may be used in a powdery form, or may be dissolved, dispersed, or suspended in a solution. It may be used in the form of an aqueous solution.

Further, the order of the addition of the mixing aid is not also particularly limited. Any method such as a method which comprises adding a mixing aid to a water absorbent resin and then adding and mixing an aqueous solution to the mixture, and a method which comprises dissolving a mixing aid in an aqueous solution, and simultaneously mixing the resultant solution with a water absorbent resin can be used.

As the surfactant to be used herein, at least one kind of surfactant which is selected from the group consisting of nonionic surfactants or anionic surfactants possessing an HLB of not less than 7 may be adopted. As concrete examples of such surfactants, sorbitan aliphatic esters, polyoxyethylene sorbitan aliphatic esters, polyglycerin aliphatic esters, polyoxyethylene alkyl ethers, polyoxyethylene alkylphenol ethers, polyoxyethylene acyl esters, sucrose aliphaatic esters, higher alcohol sulfuric esters, alkyl naphthalene sulfonates, alkylpolyoxyethylene sulfate, and dialkyl sulfosuccinates may be cited. Among these surfactants, polyoxyethylene alkyl ethers can be used. The number average molecular weight of the polyoxyethylene alkyl ether should be in the range of 200 to 100,000, or in the range of 500 to 10,000. If the number average molecular weight is too large, the solubility in water decreases and thus the mixing with the water absorbent resin becomes inefficient because the concentration of the surfactant in the solution can not be increased and the viscosity of the solution is also increased. Conversely, if the number average molecular weight is too small, the surfactant becomes less effective as a mixing aid.

As concrete examples of the water-soluble polymer, polyvinyl alcohol, polyethylne oxide, polyethylene glycol, polypropylene glycol, polyacrylamide, polyacrylic acid, sodium polyacrylate, polyethylene imine, methyl cellulose, carboxymethyl cellulose, hydroxyethyl cellulose, hydroxypropyl cellulose, dextrin, sodium alginate, and starch may be cited. Among these polymers, polyethylene glycol can be used. The number average molecular weight of the polyethylene glycol, like polyoxyethylene alkyl ether, should be in the range of 200 to 100,000, or in the range of 500 to 10,000.

As concrete examples of the hydrophilic organic solvent, alcohols such as methyl alcohol, ethyl alcohol, propyl alcohol, isopropyl alcohol, butyl alcohol, isobutyl alcohol, and t-butyl alcohol; ketones such as acetone and methylethyl ketone; ethers such as dioxane, alkoxy(poly)ethylene glycol, and tetrahydrofuran; amides such as α-caprolactam and N,N-dimethyl formamide; sulfxides such as dimethyl sulfoxide; and polyhydric alcohols such as ethylene glycol, diethylene glycol, propylene glycol, triethylene glycol, tetraethylene glycol, 1,3-propane diol, dipropylene glycol, 2,2,4-trimethyl-1,3-pentane diol, glycerin, 2-butene-1,4-diol, 1,3-butane diol, 1,4-butane diol, 1,5-pentane diol, 1,6-hexane diol, 1,2-cyclohexane dimethanol, 1,2-cyclohexanol, trimethylol propane, diethanol amine, triethanol amine, polyoxypropylene, pentaerythritol, and sorbitol may be cited. These hydrophilic organic solvents may be used either singly or in the form of a mixture of two or more members.

As concrete examples of the water-soluble inorganic compound, alkali metal salts such as sodium chloride, sodium hydrogen sulfate, and sodium sulfate, ammonium salts such as ammonium chloride, ammonium hydrogen sulfate, and ammonium sulfate, alkali metal hydroxides such as sodium hydroxide and potassium hydroxide, polyvalent metals such as aluminium chloride, polyaluminium chloride, aluminium sulfate, potassium alum, calcium chloride, alkoxy titanium, zirconium ammonium carbonate, zirconium acetate, and non-reducible alkali metal salt pH buffer agents such as hydrogencarbonate, dihydrogen phosphate, and monohydrogen phosphate may be cited.

Further, as concrete examples of the inorganic acid (salt), hydrochloric acid, sulfuric acid, phosphoric acid, carbonic acid, and boric acid, and the salts thereof, for example, alkali metal salts thereof, and alkali earth metal salts thereof may be cited. As concrete examples of the organic acid (salt), acetic acid, propionic acid, lactic acid, citric acid, succinic acid, malic acid, and tartaric acid, and the salts thereof, for example, alkali metal salts thereof, and alkali earth metal salts thereof may be typically cited.

Among the compounds cited above, at least one water-soluble or water-dispersible compound selected from the group consisting of polyoxyethylene alkyl ethers, polyethylene glycol, water-soluble polyvalent metals, sodium chloride, ammonium hydrogen sulfate, ammonium sulfate, sulfuric acid, and hydrochloric acid may be used as the mixing aid.

These mixing aids can be used singly or in the mixed form of two or more members. The amount of the mixing aid to be added is not particularly limited as long as it represses the aggregation of the water absorbent resin with water, and improves the mixing of the aqueous solution with the water absorbent resin, as mentioned above. Typically, the mixing aid may be added in an amount in the range of 0.01 to 40 parts by weight or 0.1 to 5 parts by weight, to 100 parts by weight of the water absorbent resin. Alternatively, in this invention, the mixing aid may be used in an aqueous solution form with a concentration in the range of 0-40 wt. %, or in the range of 0.01-30 wt. %, or even in the range of 0.1-10 wt. %, based on the whole amount of the aqueous solution.

As regards the method for mixing the water absorbent resin and the radical polymerization initiator, a method which effects the mixture by the use of an ordinary mixing device such as, for example, V-shape mixer, ribbon type mixer, screw type mixer, rotary circular plate type mixer, air-current type mixer, batch kneader, continuous kneader, paddle type mixer, or space type mixer may be cited as an example.

(e) Active Energy Rays

The fact that in the production of a water absorbent resin, the rate of polymerization is exalted by the exposure to active energy rays belongs to the public knowledge. For example, by compounding a polymerizable monomer component and an internal crosslinking agent and a photopolymerization initiator together and irradiating the resultant mixture with active energy rays such as ultraviolet rays, electron radiation, or γ rays, it is made possible to prepare an insoluble water absorbent resin possessing internal crosslinks. Then, as a method for crosslinking the surface of a water absorbent resin, the formation of a surface crosslinkage attained by using a surface crosslinking agent and promoting the relevant reaction by application of heat is known to the public. For the surface crosslinkage of the water absorbent resin, compounds such as polyhydric alcohols, polyvalent glycidyl ethers, haloepoxy compounds, and polyvalent aldehydes which possess a plurality of functional groups in the molecular unit are used. Generally, by heating at 100-300° C., these functional groups are enabled to react with the carboxyl group present on the surface of the water absorbent resin and give rise to a crosslinked structure on the surface of the water absorbent resin. According to this invention, however, it is possible to form a crosslinked structure on the surface of the water absorbent resin by the use of the radical polymerization initiator and the exposure of the active energy rays without requiring the presence of such a surface crosslinking agent and a polymerizable monomer. By the method disclosed herein, it is further made possible to exalt the absorbency against pressure (AAP) of the modified water absorbent resin and the saline flow conductivity (SFC).

Herein, the irradiation of the active energy rays may be carried out during the course of mixing the water absorbent resin and the radical polymerization initiator or subsequent to the mixture of these two components. From the viewpoint of forming a uniform surface crosslinkage, however, it is preferred to adopt a method which comprises preparing a mixture of a water absorbent resin and an aqueous solution containing a water soluble radical polymerization initiator and irradiating the resultant mixture with active energy rays.

As concrete examples of the active energy rays, ultraviolet rays, electron radiation, and γ rays may be cited. These active energy rays may be used either singly or in the form of a combination of two or more members. Among these active energy rays, ultraviolet rays and electron radiation prove advantageous. In consideration of the influence of active energy rays on the human body, the ultraviolet rays prove preferable and the ultraviolet rays possessing a wavelength not exceeding 300 nm and may fall in the range of 180-290 nm.

As regards the conditions of the irradiation, when the ultraviolet rays are used, the intensity of irradiation may fall in the range of 3-1000 mW/cm² and the dose falls in the range of 100-10000 mJ/cm². As concrete examples of the device for irradiating the ultraviolet rays, high-pressure mercury-vapor lamp, low-pressure mercury-vapor lamp, metal halide lamps, xenon lamp, and halogen lamps may be cited. So long as the ultraviolet rays, e.g. the ultraviolet rays of a wavelength of not more than 300 nm, is used, it may contain other radiation and wavelength and the procedure is not particularly restricted. When the electron radiation is used, e.g the voltage of acceleration falls in the range of 50-800 kV and the absorbed dose in the range of 0.1-100 Mrad.

Generally, the duration of the irradiation of the active energy rays may be not less than 0.1 minute and less than 60 minutes, or not less than 0.2 minute and less than 30 minutes, or even not less than 1 minute and less than 15 minutes. This duration possibly exceeds 60 minutes when the conventional surface crosslinking agent is used. For the fixed crosslink density, this invention can curtail the duration of the surface crosslinking treatment.

When the surface treatment is effected by the irradiation of the active energy rays, no application of heat is required. The irradiation of the active energy rays, however, possibly results in inducing generation of radiant heat. Generally, it suffices to treat the water absorbent resin at a temperature possibly not exceeding 150° C., or not exceeding 120° C., or even falling in the range of room temperature to 100° C., or even falling in the range of 50-100° C. Thus, this invention allows the treating temperature to be set at a lower level than the conventional surface treating temperature.

During the irradiation of the active energy rays, the water absorbent resin should be kept stirred. By this stirring, it is made possible to irradiate the mixture of the radical polymerization initiator and the water absorbent resin uniformly with the active energy rays. As concrete examples of the device for stirring the water absorbent resin during the irradiation of the active energy rays, shaking mixer, shaking feeder, ribbon type mixer, conical ribbon type mixer, screw type mixing extruder, air current type mixer, batch kneader, continuous kneader, paddle type mixer, high-speed fluidifying mixers, and buoyant fluidifying mixer may be cited.

It is generally known that a reaction involving a radical as an active species is inhibited by oxygen. In the method of production disclosed herein, however, the solid state properties of the surface-treated water absorbent resin do not decrease when oxygen is present in the system. From this fact, it is concluded that during the irradiation of the active energy rays, the atmosphere used for enclosing the reaction system does not need to be inert.

(f) Other Treatment

After the irradiation of the active energy rays, the water absorbent resin may be optionally subjected to a heat treatment at a temperature in the range of 50-250° C. as for the purpose of drying.

Further, after the irradiation of the active energy rays, the water absorbent resin may be endowed with a surface crosslinkage by the use of any of the conventionally known surface crosslinking agents such as polyhydric alcohols, polyvalent epoxy compounds, and alkylene carbonates.

In the method for producing the modified water absorbent resin for use in absorbent members of the present invention, the water absorbent resin may add an agent for enhancing the flow of fluid before or after or during the irradiation of the active energy rays. As concrete examples of the fluidity enhancer, minerals such as talc, kaolin, fuller's earth, bentonite, activated clay, cawk, natural asphaltum, strontium ore, ilmenite, and pearlite; aluminum compounds such as aluminum sulfates 14-18 hydrates (or anhydrides), potassium aluminum sulfates 12 hydrate, sodium aluminum sulfate 12 hydrate, aluminum chloride, aluminum polychloride, and aluminum oxide, and aqueous solutions thereof; other polyvalent metal salts; hydrophilic amorphous silicas (such as, for example, the product of the dry method made by Tokuyama K.K. and sold under the trademark designation of “Reolosil QS-20” and the products of the precipitation method made by DEGUSSA Corp. and sold under the trademark designation of “Sipernat 22S and Sipernat 2200”); and oxide composites such as silicon oxide·aluminum oxide·magnesium oxide composite (such as, for example, the product of ENGELHARD Corp. sold under the trademark designation of “Attagel #50), silicon oxide-aluminum oxide composite, and silicon oxide·magnesium oxide composite may be cited. Such a fluidity enhancer in an amount possibly falling in the range of 0-20 weight parts, or in the range of 0.01-10 weight parts, or even in the range of 0.1-5 weight parts is mixed with 100 weight parts of the water absorbent resin which has been modified. The fluidity enhancer can be added in the form of aqueous solution when it is soluble in water or in the form of powder or slurry when it is insoluble. The fluidity enhancer may be added in the form mixed with a radical polymerization initiator. Other additives such as antibacterial agent, deodorant, and chelating agent may be properly used additionally in an amount falling in the range mentioned above.

(g) Modified Water Absorbent Resin

When the method for producing a modified water absorbent resin for use in absorbent members of this invention is carried out, the produced water absorbent resin gains improved absorbency against pressure thereof. It has been hitherto known that the formation of surface crosslinkage results in slightly lowering the free swelling capacity but exalting the ability to retain the absorbed liquid even in a pressed state, namely the absorbency against pressure. By the method disclosed herin, the absorbency against pressure of 4.83 kPa of the water absorbent resin is improved by not less than 1 g/g comparing with the absorption against pressure of the resin prior to the modification. This fact is thought to indicate that the method of this invention has introduced a crosslinked structure to the surface of the water absorbent resin. As the properties after the modification, this improvement may be not less than 8 g/g, or not less than 12 g/g, or not less than 15 g/g, or even not less than 20 g/g, or even not less than 22 g/g. The modified water absorbent resin for use in absorbent members of this invention exhibits the absorbency against pressure of 4.83 kPa in the range of 8-40 g/g. Though the upper limit of this absorbency against pressure does not particularly matter, the neighborhood of 40 g/g may prove sufficient at times on account of the rise of cost due to the difficulty of production.

Then, the free swelling capacity (GV) may be not less than 8 g/g, or not less than 15 g/g, or not less than 20 g/g, or even not less than 25 g/g. Though the upper limit is not particularly restricted, it should be not more than 50 g/g, or not more than 40 g/g, or even not more than 35 g/g. If the free swelling capacity (GV) falls short of 8 g/g, the water absorbent resin will not fit use for such sanitary materials as disposable diapers because of an unduly small amount of absorption. Conversely, if the free swelling capacity (GV) exceeds 50 g/g, the overage will possibly result in preventing the produced water absorbent resin from acquiring an excellent ability to pass fluid because of deficiency in gel strength.

The modified water absorbent resin which is obtained by the method disclosed herein possesses a property of saline flow conductivity (SFC) which may be not less than 10 (×10⁻⁷·cm³·s·g⁻¹), or not less than 30 (×10⁻⁷·cm³·s·g⁻¹), or not less than 50 (×10⁻⁷·cm³·s·g⁻¹), or even not less than 70 (×10⁷·cm³·s·g⁻¹), or even not less than 100 (×10⁻⁷·cm³·s·g⁻¹). These numerical values are to be determined by the method specified in the working example cited herein below.

Further, the modified water absorbent resin which is obtained by the method disclosed herein has an extremely low residual monomer content. This is considered to be because the initiator radicals to be formed by the irradiation of the radical polymerization initiator with ultraviolet rays react with the remaining monomers in the water absorbent resin. Since the water absorbent resin is used in disposable diapers, the residual monomer content should be as small as possible in terms of odor and safety. While the residual monomer content of the water absorbent resin as a base polymer is generally in the range of 200 to 500 ppm, the residual monomer content of the surface-treated water absorbent resin obtained by this invention is mostly not more than 200 ppm (the lower limit is 0 ppm). The residual monomer content of the modified water absorbent resin may be not more than 200 ppm, or not more than 150 ppm, or not more than 100 ppm (the lower limit is 0 ppm).

Further, the modified water absorbent resin which is obtained by the method disclosed herein has a small solid content as compared with a modified water absorbent resin which is obtained by a conventional modifying method which comprises adding a surface-treatment agent to a water absorbent resin as a base polymer and heating the mixture at an elevated temperature. This is because according to the method disclosed herein, the reaction does not require an elevated temperature and thus most of water contained in the aqueous solution which is added to the water absorbent resin as a base polymer remains even after the reaction. The large water content of the water absorbent resin has such effects that the amount of fine powder having a particle size of not more than 150 μm which is not desirable in terms of health can be decreased, the generation of static electricity on the particle surface which causes the blocking during the pneumatic conveying can be prevented, and the deterioration of physical properties by physical damage during the pneumatic conveying can be repressed. The solid content of the modified water absorbent resin may be not more than 95%, or not more than 93%, or not more than 91%. Although the lower limit is not critical, a solid content not more than 70% has a possibility of not being desirable in some uses, because in such a case, the absorbency per weight of the water absorbent resin decreases.

Therefore, the present invention relates to a powdery modified water absorbent resin for use in absorbent members and to be obtained by polymerizing a monomer component having as main component acrylic acid (salt), characterized by having (i) saline flow conductivity of not less than 40 (10⁻⁷·cm³·s·g⁻¹), (ii) a solid content of not more than 95%, and (iii) a residual monomer content of not more than 150 ppm. In this case, the modified water absorbent resin may have free swelling capacity of physiological saline of not less than 25 g/g and/or absorbency of physiological saline against pressure of 4.83 kPa of not less than 22 g/g. These numerical values are to be determined by the method specified in the working example cited herein below.

The form of the surface-treated water absorbent resin which is obtained by the method disclosed herein can be properly adjusted by the conditions of treatment such as the form of the water absorbent resin before the treatment and the agglomeration and molding of the treated water absorbent resin after the treatment. Generally, however, the modified water absorbent resin has a powdery form. This powder has a weight average particle diameter (specified by classification with sieves) which falls in the range of 10-1,000 μm or in the range of 200-600 μm. In this powder, the content of particles having diameters of 150-850 μm may fall in the range of 90-100% by weight or in the range of 95-100% by weight based on the weight of the water absorbent resin.

The method of production as disclosed herein, during the course of surface crosslinking the water absorbent resin, manifests an effect of agglomerating the fine powder which occurs during the production of the modified water absorbent resin. Thus, even when the water absorbent resin prior to the modification happens to contain the fine powder, the method disclosed herein for producing the modified water absorbent resin is capable of agglomerating the contained fine powder and, therefore, decreasing the amount of the fine powder to be contained in the resultant modified water absorbent resin. The particle size distribution of the produced modified water absorbent resin is shifted toward a higher particle size as compared with the water absorbent resin prior to the modification. The degree of the shift, however, varies with the kind and amount of the radical polymerization initiator to be mixed with the water absorbent resin and, when it is added as an aqueous solution, with the water content, the conditions of irradiation of the active energy rays, and the method for fluidization during the irradiation.

The modified water absorbent resin which is obtained by the method disclosed herein has a surface crosslinkage formed uniformly at a high density throughout on the entire surface of the water absorbent resin and is enabled to exalt to extremely high levels such characteristic properties as absorption capacity, absorption speed, gel strength, and suction force which the water absorbent resin is expected to possess. When an acrylic acid type water absorbent resin was surface crosslinked by the use of such a surface crosslinking agent as polyhydric alcohol, polyvalent epoxy compound, or alkylene carbonate, the speed and the extent of the surface crosslinkage were found to depend on the ratio of neutralization. To be specific, the surface crosslinking proceeded fast when the ratio of neutralization was low and the surface crosslinkage was not easily effected when the rate of neutralization was high. For the purpose of surface crosslinking the water absorbent resin which is obtained by the post-neutralization, the post-neutralization was required to be performed uniformly after the surface crosslinking treatment. This invention, however, is capable of modifying the water absorbent resin and producing the water absorbent resin excelling in the water absorbing property without requiring to depend on the ratio of neutralization of the water absorbent resin or on the uniformity of the post-neutralization. It is inferred that the surface crosslinkage depends on the action of the radical polymerization initiator on the main chain of the water absorbent resin and, therefore, proceeds irrespectively of the question whether the carboxyl group continues to exist in the form of an acid or has been reduced to a salt.

When the method disclosed herein is executed in the presence of an ethylenically unsaturated monomer, the execution does not conform to the object of this invention because the radical polymerization initiator is consumed by the polymerization of the ethylenically unsaturated monomer.

In accordance with this invention, the surface treatment of the water absorbent resin is effected fully satisfactorily even at a reaction temperature in the neighborhood of room temperature and the surface-treated water absorbent resin consequently obtained is enabled to manifest at extremely high levels such characteristic properties as absorption capacity, absorption speed, gel strength, and suction force which the water absorbent resin is expected to possess. The water absorbent resin which is obtained by the method disclosed herein, therefore, is optimally usable for sanitary cotton, disposable diapers, and other sanitary materials for absorbing body fluid and for agricultural activities.

Disposable Diapers

The water absorbent resin produced according to the method disclosed herein is used in absorbent members. These absorbent members are comprised in disposable diapers, typically the absorbent members are comprised in the absorbent core.

As used herein, “diaper” refers to an absorbent article generally worn by infants and incontinent persons about the lower torso. “Absorbent article” refers to devices that absorb and contain liquid, and more specifically, refers to devices that are placed against or in proximity to the body of the wearer to absorb and contain the various exudates discharged from the body.

The term “diaper” according to this invention comprises so-called tape-diapers, i.e. diapers which are attached and secured onto the wearer, preferably a baby or a small child of less than 5 years, by using a fastening system such as adhesive tapes or mechanical tapes). The term “diaper” according to this invention also comprises pull-on diapers and training pants, i.e. diapers having closed sides and which are applied onto the wearer like conventional underwear. The term “diaper” also comprises any combinations between the mentioned diaper types.

Disposable diapers especially suitable for the present invention typically comprise an outer covering including a liquid pervious topsheet, a backsheet, which is preferably liquid impervious and an absorbent core generally disposed between the topsheet and the backsheet. The absorbent core may comprise any absorbent material that is generally compressible, conformable, non-irritating to the wearer's skin, and capable of absorbing and retaining liquids such as urine and other certain body exudates. In addition to the water absorbent resin of the present invention, the absorbent core may comprise a wide variety of liquid-absorbent materials commonly used in disposable diapers and other absorbent articles such as comminuted wood pulp, which is generally referred to as air felt.

The absorbent core typically comprises at least one fluid acquisition layer and at least one fluid storage layer. The fluid acquisition layer is typically facing towards the topsheet while the fluid storage layer is typically facing towards the backsheet of the diaper.

Exemplary absorbent structures for use as the absorbent assemblies are described in U.S. Pat. Nos. 5,137,537; 5,147,345; 5,342,338; 5,260,345; 5,387,207; 5,397,316; and 5,625,222.

In one embodiment of the present invention, the water absorbent resin produced according to the method disclosed herein is comprised in the fluid storage layer of the absorbent core in amounts of at least 80% by weight of the total fluid storage layer, or in amounts of at least 85%, or in amounts of at least 90% or even more than 95%. To allow use of these relatively high concentrations of water absorbent resin, the water absorbent resin must fulfil certain parameters ranges (like the range of absorbency against pressure and saline flow conductivity). Otherwise, so-called gel-blocking occurs

After absorption of an aqueous solution, non-modified, swollen water absorbent resin particles become very soft and deform easily. Upon deformation the void spaces between the water absorbent resin particles are blocked, which drastically increases the flow resistance for liquids. This is generally referred to as “gel-blocking”. In gel blocking situations liquid can move through the swollen water absorbent resin particles only by diffusion, which is much slower than flow in the interstices between the water absorbent resin particles.

The risk of gel-blocking is especially high if the absorbent member comprises high amounts of water absorbent resin and only comprises small amounts of other liquid absorbent materials, such as cellulose fibers. Hence, the water absorbent resin must be modified accordingly to avoid gel-blocking even if high amounts of water absorbent resin is applied, e.g. the water absorbent resin must be modified to have a relatively high SFC values and high absorbency under pressure values. The water absorbent resin modified according to the method disclosed herein is modified accordingly to allow for the use of high amounts of water absorbent resin.

In order to increase the integrity of the absorbent core, the core may comprise water absorbent resin made according to the method disclosed herein embedded in a matrix of thermoplastic resin or a matrix of hot melt adhesive or mixtures thereof.

If the fluid storage layer comprises relatively high amounts of water absorbent resin as is preferred herein, the absorbent core or at least the fluid absorbent layer may be enveloped in a so-called core wrap, e.g. a nonwoven sheet which is wrapped around the absorbent core to prevent water absorbent resin particles from escaping from the absorbent core.

### METHODS AND EXAMPLES

Now, this invention will be described more specifically below with reference to working examples and comparative examples. This invention is not limited thereto. Hereinafter, the “weight parts” may be expressed simply as “parts” and the “liters” simply as “L” for the sake of convenience. The method of determination and the method of evaluation indicated in the working examples and the comparative example will be shown below.

(1) Particle Size Distribution

Ten gram samples of a given water absorbent resin before the surface treatment and after the surface treatment are classified with test sieves having a diameter of 75 mm and mesh sizes of 850 μm, 600 μm, 300 μm, and 150 μm (made by Iida Seisakusho K.K.). The weights of the portions of resin consequently divided are determined to find wt. % of each particle size. The classification is effected by shaking the samples for five minutes with the sieves made by Iida Seisakusho Ltd. and sold under the trademark designation of Sieve Shaker ES-65. The water absorbent resin is dried at 60±5° C. under a reduced pressure (less than 1 mmHg (133.3 pa)) for 24 hours before it is used in the determination.

(2) Determination of Solid Content

In a cup of aluminum measuring 4 cm in bottom diameter and 2 cm in height, a 1 g sample of a given water absorbent resin is uniformly spread on the bottom surface of the aluminum cup. The sample in the cup is left standing in a hot air drier adjusted in advance to 180° C. for three hours. The solid content (%) of the water absorbent resin is calculated based on the loss of weight which occurred during the standing.

(3) Free Swelling Capacity (GV)

A 0.2 g sample of a given water absorbent resin is uniformly placed in a pouch of non-woven fabric (size: 60 mm×60 mm; made by Nangoku Pulp Kogyo K.K. and sold under the trademark of “Heatlon Paper, Model GSP-22). The pouch with the sample is immersed in a large excess of an aqueous 0.9 wt. % sodium chloride solution (physiological saline) at room temperature (25±2° C.). After 30 minutes' standing in the solution, the pouch is pulled up and drained at a centrifugal force of 250 G for three minutes by the use of a centrifugal separator. Then, the weight W₁ (g) of the pouch is determined. The same procedure is repeated without using any water absorbent resin and the weight W₂ (g) of the pouch used at that time is determined. The free swelling capacity (GV) (g/g) of the sample is calculated in accordance with the following formula using W₁ and W₂.

Free swelling capacity (g/g)=[W₁(g)−W₂(g)−Weight (g) of water absorbent resin (g)]/Weight of water absorbent resin (g).

(4) Absorbency Against Pressure (AAP)

A 400-mesh wire gauze of stainless steel (38 μm in mesh size) is welded to the bottom of a plastic supporting cylinder 60 mm in inside diameter. Under the conditions of room temperature (25±2° C.) and 50 RH % of humidity, 0.900 g of a given water absorbent resin is uniformly scattered on the wire gauze and a piston and a load each adjusted to exert a load of 4.83 kPa uniformly on the water absorbent resin, given an outside diameter slightly smaller than 60 mm, prevented from producing a gap relative to the inner wall surface of the supporting cylinder, and enabled to produce an unobstructed vertical motion were mounted thereon sequentially in the order mentioned, and the whole weight Wa (g) of the resultant measuring device is determined.

A glass filter 90 mm in diameter (pore diameters: 100-120 μm: made by Sogo Rikagaku Glass Manufactory K.K.) is placed inside a petri dish 150 mm in diameter and an aqueous 0.9 wt. % sodium chloride solution (physiological saline) (20-25° C.) is added to the petri dish till it rose to the same level as the upper surface of the glass filter. One filter paper 90 mm in diameter (0.26 mm in thickness and 5 μm in retained particle diameter; made by Advantec Toyo K.K. and sold under the product name of “JIS P 3801, No. 2”) is mounted on the physiological saline so as to have the surface thereof thoroughly wetted and the excess solution is removed.

The resultant measuring device is wholly mounted on the wetted filter paper and the water absorbent resin is allowed to absorb the solution under the load for a prescribed time. This absorption time is set at one hour as reckoned from the start of the measurement. To be specific, the whole measuring device is lifted after the one hour's standing and the weight thereof. W_{b} (g) is determined. This determination of the weight must be performed as quickly as possible without exposing the device to any vibration. The absorbency against pressure (AAP) (g/g) is calculated in accordance with the following formula using Wa and Wb.
AAP(g/g)=[W_{b}(g)−Wₐ(g)]/Weight of water absorbent resin (g)
(5) Saline Flow Conductivity (SFC)

The saline flow conductivity (SFC) is expressed by the value which indicates the degree of permeability exhibited by the particles of a given water absorbent resin in a wetted state to a relevant liquid. The SFC is an index which grows in proportion as the permeability to the liquid increases.

The determination of SFC is performed by following the test for the saline flow conductivity (SFC) described in the official gazette of International Unexamined Patent Publication HEI 9-509591 with necessary modification.

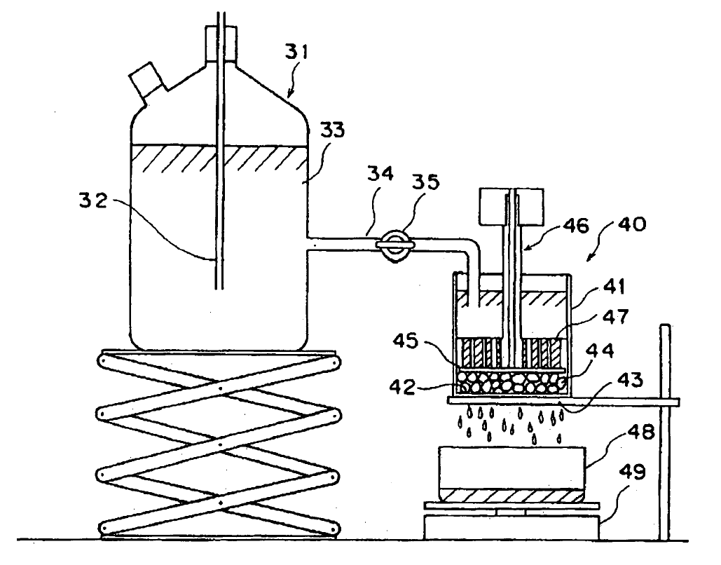

By the use of a device illustrated in FIG. 1, particles of a given water absorbent resin (0.900 g) are uniformly placed in a container 40 and left swelling in artificial urine under a pressure of 0.3 psi (2.07 kPa) for 60 minutes and the height of a layer of gel 44 is recorded. Subsequently, under a pressure of 0.3 psi (2.07 kPa), 0.69 wt. % saline 33 from a tank 31 was passed under a stated hydrostatic pressure through a swelled gel layer. This test for SFC is carried out at room temperature (20-25° C.). By means of a computer and a balance, the amounts of liquid passing the gel layer at intervals of 20 seconds are recorded as a function of time for 10 minutes. The speed of flow Fs (T) through the swelled gel 44 (mainly between adjacent particles) is decided in units of g/s by dividing the increased, weight (g) by the increased time (s). The time in which the fixed hydrostatic pressure and the stable speed of flow are attained is denoted by Ts. The data obtained during the 10 minutes after Ts are exclusively used for the calculation of the speed of flow. The value of Fs (T=0), namely the initial speed of flow through the gel layer, is calculated by using the speed of flow obtained during the 10 minutes after Ts. The Fs (T=0) was calculated by extrapolating the result of the least-squares method performed on the Fs (T) against time into T=0.

$$Saline flow conductivity ( SFC ) = ( Fs ( t = 0 ) ⨯ L 0 ) / ( ρ ⨯ A ⨯ Δ P ) = ( Fs ( t = 0 ) ⨯ L 0 ) / 139506$$

wherein Fs (t=0) denotes the speed of flow expressed in units of g/s, L0 denotes the height of the gel layer expressed in units of cm, ρ denotes the density of the NaCl solution (1.003 g/cm³), A denotes the upper side area of the gel layer in the cell 41 (28.27 cm²), ΔP denotes the hydrostatic pressure exerted on the gel layer (4920 dynes/cm², and the unit of the value of SFC is (10⁻⁷·cm·s·g⁻¹).

In the device illustrated in FIG. 1, a tank 31 has a glass tube 32 inserted therein and the lower terminal of the glass tube 32 is so disposed that an aqueous 0.69 wt. % saline 33 can be maintained to a height of 5 cm from the bottom of the swelled gel 44 held in a cell 41. The aqueous 0.69 wt. % saline solution in the tank 31 is supplied to the cell 41 via an L-letter tube 34 fitted with a cock 35. Below the cell 41, a collecting container 48 for collecting the passed liquid is disposed on a pan scale 49. The cell 41 has an inside diameter of 6 cm. A wire gauze (38 μm in mesh size) 42 of stainless steel is disposed on the bottom surface in the lower part of the cell. A piston 46 is provided in the lower part thereof with holes 47 sufficient for passing a liquid and fitted in the bottom part thereof with a glass filter 45 having good permeability capable of preventing the particles of the water absorbent resin or the swelled gel thereof from entering the hole 47. The cell 41 is laid on a stand for mounting the cell. The surface of the stand contacting the cell is placed on a wire gauze 43 of stainless steel incapable of obstructing the passage of liquid.

The artificial urine mentioned above results from adding 0.25 g of dihydrate of calcium chloride, 2.0 g of potassium chloride, 0.50 g of hexahydrate of magnesium chloride, 2.0 g of sodium sulfate, 0.85 g of ammonium dihydrogen phosphate, 0.15 g of diammonium hydrogen phosphate, and 994.25 g of purified water together.

(6) Extractable Polymer

In a lidded plastic container (measuring 6 cm in diameter×9 cm in height) having an inner volume of 250 ml, 184.3 g of an aqueous 0.900 wt % sodium chloride solution separately weighed out is placed, 1.00 g of a granular water absorbent resin is added thereto, and they are stirred together by the use of a magnetic stirrer measuring 8 mm in diameter and 25 mm in length at a rotational frequency of 500 rpm for 16 hours to extract the soluble content in the resin. The extracted solution is passed through one filter paper (0.26 mm in thickness and 5 μm in retained particle diameter; made by Advantec Toyo K.K. and sold under the product name of “JIS P 3801 No. 2”) and 50.0 g of the resultant filtrate is used for the determination.

First, an aqueous 0.900 wt % sodium chloride solution alone is titrated with an aqueous 0.1N NaOH solution till pH 10 and subsequently titrated with an aqueous 0.1N HCl solution till pH 2.7 to obtain a constant titer ([bNaOH] ml, [bHCl] ml).

By performing the same titrating operation on the solution under test, the titer ([NaOH] ml, [HCl] ml) is obtained.

In the case of the water absorbent resin which is composed of known amounts of acrylic acid and sodium salt thereof, for example, the extractable polymer of this water absorbent resin can be calculated in accordance with the following formula based on the titer which is obtained from the average molecular weight of the monomer and the aforementioned operation. When the amounts are unknown, the average molecular weight of the monomer is calculated by using the neutralization ratio found by titration.

Extractable polymer (wt %)=0.1×(average molecular weight)×184.3×100×([HCl]−[bHCl])/1000/1.0/50.0

Neutralization ratio (mol %)=[1−([NaOH]−[b(NaOH)])/([HCl]−[bHCl])]×100

(7) Residual Monomer Content

0.500 g of a water absorbent resin is dispersed in 1000 ml of deionized water. The resultant dispersion is stirred with a magnetic stirrer of 50 mm in length for 2 hours to extract a residual monomer. Then, the swollen gel is filtered using a filter (produced by Toyo Roshi Kaisha, Ltd., No. 2, remained particle size of 5 μm as defined by JIS P 3801). The filtrate is further filtered using a filter chromatodisc 25A for pretreatment of HPLC sample (produced by Kurabo Industries Ltd., water type, pore size: 0.45 μm) to prepare a sample for the determination of residual monomer content. The sample for the determination of residual monomer content is analyzed with a high performance liquid chromatography (HPLC). The residual monomer content of the water absorbent resin is determined by analyzing 12 standard solutions containing predetermined concentrations of monomer (acrylic acid) to obtain a calibration curve, using the calibration curve as an external standard and taking account into dilution rates. The operation conditions of HPLC are as follows.

Carrier solution: an aqueous phosphoric acid solution obtainable by diluting 3 ml phosphoric acid (85% by weight, produced by Wako Junyaku Kabushiki Kaisha, special grade chemicals) in 1000 ml of ultrapurified water (specific resistance: not less than 15MΩ·cm).

Carrier flow rate: 0.7 ml/min

Column: SHODEX RSpak DM-614 (produced by Showa Denko Kabushiki Kaisha)

Column temperature: 23±2° C.

Wavelength: UV 205 nm

### Production Example 1

In a kneader provided with two sigma-type blades, an acrylic acid salt type aqueous solution formed of sodium acrylate, acrylic acid, and water (monomer concentration: 38 wt. %, neutralization ratio: 75 mol %) is prepared and polyethylene glycol diacrylate (number of average ethylene oxide units, n=8) as an internal crosslinking agent is dissolved therein in a ratio of 0.05 mol % based on the monomer.

Then, nitrogen gas is blown into this aqueous solution to lower the oxygen concentration in the aqueous solution and displace the whole interior of the reaction vessel. Subsequently, with the two sigma type blades kept rotated, 0.05 mol % (based on the monomer) of sodium persulfate as a polymerization initiator and 0.0006 mol % (based on the monomer) of L-ascorbic acid are added to the vessel and the components in the kneader are stirred and polymerized for 40 minutes. Consequently, a hydrogel-like polymer having an average particle size of 2 mm is obtained.

The hydrogel-like polymer thus obtained is dried in a hot air drier set at 170° C. for 45 minutes. Then, the dried polymer is pulverized in a roll mill powdering machine and classified with a sieve having a mesh size of 850 μm to remove particles having particle diameters larger than 850 μm and obtain a powdery water absorbent resin (A) as a base polymer.

The water absorbent resin (A) consequently obtained as the base polymer is rated for various properties. The results are shown in Table 1.

The particle size distribution of the water absorbent resin (A) obtained as the base polymer is shown in Table 2.

### Example 1

In a separable flask of quartz, 10 g of the water absorbent resin (A) as the base polymer is placed and stirred with stirring vanes and 1.05 g of an aqueous 23.8 wt % ammonium persulfate solution is added to the stirred base polymer. After the stirring is continued for 15 minutes, the stirred mixture consequently obtained is irradiated with the ultraviolet rays emitted from an ultraviolet rays radiating device (made by Ushio Denki K.K. and sold under the product code of UV-152/IMNSC3-AA06) furnished with a metal halide lamp (made by the same company and sold under the product code of UVL-1500M2-N1) at a radiation intensity of 60 mW/cm² for 10 minutes to obtain a surface-treated water absorbent resin (1). The conditions for the surface treatment and the water absorbing properties are shown in Table 3.

### Example 2

A surface-treated water absorbent resin (2) is obtained by following the procedure of Example 1 while using 1.30 g of an aqueous 38.5 wt % ammonium persulfate solution.

### Example 3

A surface-treated water absorbent resin (3) is obtained by following the procedure of Example 2 while changing the duration of the irradiation with the ultraviolet rays to 5 minutes.

### Example 4

A surface-treated water absorbent resin (4) is obtained by following the procedure of Example 1 while using 1.30 g of an aqueous 38.5 wt % sodium persulfate solution.

### Comparative Example 1

A surface-treated water absorbent resin (1) for comparison is obtained by following the procedure of Example 2 while utilizing 10 minutes' heating in a hot water bath at 80° C. in the place of the irradiation of the ultraviolet rays.

### Production Example 2

A hydrogel-like polymer is obtained by following the procedure of Production Example 1 while changing the amount of the internal crosslinking agent to 0.065 mol % based on the monomer. The hydrogel-like polymer consequently obtained is dried in a hot air drier set at 175° C. for 50 minutes. Then, the dried polymer is pulverized with a roll mill powdering machine and classified with a sieve having a mesh size of 500 μm and a sieve having a mesh size of 300 μm to remove particles having particle diameters larger than 500 μm and particles having particle diameters smaller than 300 μm and obtain a water absorbent resin (B) as a base polymer.

The water absorbent resin (B) consequently obtained as the base polymer is rated for various properties. The results are shown in Table 1.

The particle size distribution of the water absorbent resin (B) obtained as the base polymer is shown in Table 2.

### Example 5

A surface-treated water absorbent resin (5) is obtained by following the procedure of Example 1 while using 10 g of the water absorbent resin (B) as the base polymer and using 1.3 g of an aqueous 38.5 wt % sodium persulfate solution.

### Comparative Example 2

A surface-treated water absorbent resin (2) for comparison is obtained by following the procedure of Example 5 while omitting the use of a radical polymerization initiator and using 0.8 g of deionized water instead.

### Comparative Example 3

A water absorbent resin (3) for comparison is obtained by following the procedure of Example 5 while using a step of effecting application of heat in a hot air drier adjusted in advance to 180° C. for 1 hour in the place of the irradiation of the ultraviolet rays.

### Example 6

A surface-treated water absorbent resin (6) is obtained by following the procedure of Example 5 while using a mixed solution consisting of 1.3 g of an aqueous 0.38.5 wt % sodium persulfate solution and 0.2 g of an aqueous 50 wt % aluminum sulfate solution instead.

### Comparative Example 4

A surface-treated water absorbent resin (4) for comparison is obtained by following the procedure of Example 5 while using 0.2 g of an aqueous 50 wt % aluminum sulfate solution instead.

### Comparative Example 5

A water absorbent resin (5) for comparison is obtained by following the procedure of Example 6 while using a step of effecting application of heat in a hot air drier adjusted in advance to 180° C. for 1 hour in the place of the irradiation of the ultraviolet rays.

### Production Example 3

A hydrogel-like polymer is obtained by following the procedure of Production Example 1 while changing the amount of the internal crosslinking agent to 0.09 mol % based on the monomer. The hydrogel-like polymer thus obtained is dried in a hot air drier set in advance at 175° C. for 50 minutes. The dried polymer is pulverized with a roll mill powdering machine. The resultant powder is classified with a sieve having a mesh size of 600 μm to remove particles having particle sizes larger than 600 μm and obtain a powdery water absorbent resin (C) as a base polymer.

The powdery water absorbent resin (C) obtained as the base polymer is rated for various properties. The results are shown in Table 1.

The particle size distribution of the powdery water absorbent resin (C) obtained as the base polymer is shown in Table 2.

### Example 7

A surface-treated water absorbent resin is obtained by following the procedure of Example 5 while using 10 g of the water absorbent resin (C) as the base polymer. A water absorbent resin (7) is obtained allowing the produced water absorbent resin to stand in a vacuum drier adjusted in advance to 60° C. under a reduced pressure for 12 hours. The produced water absorbent resin (7) is found to have a solid content (specified by the weight loss by drying at 180° C. for 3 hours) of 94.0% by weight.

### Example 8

A water absorbent resin (8) is obtained by following the procedure of Example 7 while using a mixed solution consisting of 1.3 g of an aqueous 38.5 wt % of sodium persulfate and 0.2 g of an aqueous 50 wt % aluminum sulfate solution instead. The produced water absorbent resin (8) is found to have a solid content (specified by the weight loss by drying at 180° C. for 3 hours) of 93.3% by weight.

### Example 9

A water absorbent resin (9) is obtained by following the procedure of Example 7 while using a mixed solution consisting of 1.3 g of an aqueous 38.5 wt % of sodium persulfate and 0.2 g of a solution resulting from mixing an aqueous 50 wt % aluminum sulfate solution and an aqueous 50 wt % sodium lactate at a ratio of 5:1 instead. The produced water absorbent resin (9) is found to have a solid content (specified by the weight loss by drying at 180° C. for 3 hours) of 93.7% by weight.

### Example 10

A surface-treated water absorbent resin (10) is obtained by following the procedure of Example 1 except that 0.25 g of ammnoium hydrogen sulfate was added to the aqueous ammonium persulfate solution.

### Example 11

A surface-treated water absorbent resin (11) is obtained by following the procedure of Example 1 except that 0.25 g of ammnoium sulfate was added to the aqueous ammonium persulfate solution.

### Example 12

A surface-treated water absorbent resin (12) is obtained by following the procedure of Example 1 except that 0.25 g of sodium chloride is added to the aqueous ammonium persulfate solution.

### Example 13

A surface-treated water absorbent resin (13) is obtained by following the procedure of Example 1 except that 0.165 g of ammnoium sulfate and 0.11 g of sulfuric acid are added to the aqueous ammonium persulfate solution.

### Example 14

A surface-treated water absorbent resin (14) is obtained by following the procedure of Example 2 except that a mixed solution containing 0.1 g of an aqueous 50 wt % aluminum sulfate 14-18 hydrate solution, 0.0025 g of propylene glycol, and 0.0167 g of an aqueous 60 wt % sodium lactate solution was added to the water absorbent resin (A) prior to the addition of the aqueous ammonium persulfate solution.

### Example 15

A surface-treated water absorbent resin (15) is obtained by following the procedure of Example 2 except that 0.05 g of polyethylene glycol monomethylether (number average molecular weight: about 2,000) is added to the aqueous ammonium persulfate solution.

### Example 16

A surface-treated water absorbent resin (16) is obtained by following the procedure of Example 1 except that 10 g of the water absorbent resin (C) is used as the base polymer.

### Example 17

A surface-treated water absorbent resin (17) is obtained by following the procedure of Example 16 except that 0.05 g of polyethylene glycol monomethylether (number average molecular weight: about 2,000) is added to the aqueous ammonium persulfate solution.

### Production Example 4

A hydrogel-like polymer is obtained by following the procedure of Production Example 1 while changing the neutralization ratio of the acrylic acid salt type aqueous monomer solution to 60 mol % and also changing the amount of the internal crosslinking agent to 0.06 mol % based on the monomer. The hydrogel-like polymer thus obtained is dried in a hot air drier set in advance at 175° C. for 50 minutes. The dried polymer is pulverized with a roll mill powdering machine. The resultant powder is classified with a sieve having a mesh size of 600 μm to remove particles having particle sizes larger than 600 μm and obtain a powdery water absorbent resin (D) as a base polymer.

The powdery water absorbent resin (D) obtained as the base polymer is rated for various properties. The results are shown in Table 1.

The particle size distribution of the powdery water absorbent resin (D) obtained as the base polymer is as the same as that of the powdery water absorbent resin (C).

### Example 18

A surface-treated water absorbent resin (18) is obtained by following the procedure of Example 2 except that 10 g of the water absorbent resin (D) is used as the base polymer.

### Example 19

A surface-treated water absorbent resin (19) is obtained by following the procedure of Example 18 except that 0.05 g of polyethylene glycol monomethylether (number average molecular weight: about 2,000) is added to the aqueous ammonium persulfate solution.

### Production Example 5

In a kneader provided with two sigma-type blades, an aqueous acrylic acid solution (monomer concentration: 30 wt. %) is prepared and methylene bisacrylamide as an internal crosslinking agent is dissolved therein in a ratio of 0.15 mol % based on the monomer.

Then, nitrogen gas is blown into this aqueous solution to lower the oxygen concentration in the aqueous solution and exchange the atmosphere of the whole interior of the reaction vessel. Subsequently, with the two sigma type blades being rotated, 0.016 mol % (based on the monomer) of 2,2′-azobis(2-amidinopropane)-dihydrochloride as a polymerization initiator and 0.002 mol % (based on the monomer) of L-ascorbic acid and 0.04 mol % (based on the monomer) of hydrogen peroxide are added to the vessel. When the viscosity of the aqueous acrylic acid solution increased, the rotation of the blades is stopped, and the stationary polymerization is carried out in the kneader. After the temperature of the produced gel reaches the peak, the temperature of the jacket of the kneader is set at 70° C. and the gel is left standing for one hour. Subsequently, the blades of the kneader is re-rotated to pulverize the gel for 20 minutes. Then, an aqueous 20 wt. % sodium carbonate solution (equivalent to 60 mol % mol, based on the monomer) is added while the blades are kept rotating and mixing is continued for 60 minutes. Consequently, a hydrogel-like polymer having an average particle size of 2 mm is obtained.

The hydrogel-like polymer thus obtained is dried in a hot air drier set at 175° C. for 50 minutes. Then, the dried polymer is pulverized in a roll mill powdering machine and classified with a sieve having a mesh size of 600 μm to remove particles having particle diameters larger than 600 μm and obtain a powdery water absorbent resin (E) as a base polymer.

The water absorbent resin (E) consequently obtained as the base polymer is rated for various properties. The results are shown in Table 1.

The particle size distribution of the powdery water absorbent resin (E) obtained as the base polymer is as the same as that of the powdery water absorbent resin (C).

### Example 20

A surface-treated water absorbent resin (20) is obtained by following the procedure of Example 2 except that 10 g of the water absorbent resin (E) is used as the base polymer.

### Example 21

A surface-treated water absorbent resin (21) is obtained by following the procedure of Example 20 except that 0.05 g of polyethylene glycol monomethylether (number average molecular weight: about 2,000) is added to the aqueous ammonium persulfate solution.

The produced surface-treated water absorbent resin is rated for various properties. The results are shown in Tables 1-4.

TABLE 1

| | | Extractable | Water |
|---|---|---|---|
| | GV (g/g) | polymer (%) | content (%) |
| Base polymer (A) | 34.5 | 12.4 | 92.3 |
| Base polymer (B) | 33.4 | 9.2 | — |
| Base polymer (C) | 32.8 | 7.9 | 93.3 |
| Base polymer (D) | 36.7 | 14.7 | 95.4 |
| Base polymer (E) | 35.0 | 2.3 | 94.8 |

TABLE 2

| | Production | Production | Production |
|---|---|---|---|
| Particle | Example 1 base | Example 2 base | Example 3 base |
| size | polymer (A) | polymer (B) | polymer (C) |
| 850 μm< | 0.0% | 0.0% | 0.0% |
| 600-850 μm | 28.0% | 0.0% | 0.0% |
| 300-600 μm | 54.8% | 100.0% | 67.3% |
| 300-150 μm | 15.0% | 0.0% | 30.5% |
| 150 μm> | 2.2% | 0.0% | 2.2% |

TABLE 3

| | | | Conditions for surface treatment | | | | | | | | |
|---|---|---|---|---|---|---|---|---|---|---|---|
| | | | Water-soluble | | | | Water absorbing properties | | | | |
| | | | radical | | | Other | | | SFC | Residual | Solid |
| | | Base | polymerization | Initiator | UV or | additive | GV | AAP | (10⁻⁷ · cm³ · | Monomer | content |
| | | polymer | initiator | (wt. %) | heating | (wt. %) | (g/g) | (g/g) | s · g⁻¹) | (ppm) | (%) |
| Prod. Ex. 1 | BP* (A) | — | — | — | — | — | 34.5 | 7.5 | 0 | 271 | 92.3 |
| Ex. 1 | WAR** (1) | (A) | Ammonium | 2.5 | UV 10 min. | — | 25.8 | 18.7 | 28 | 142 | 86.3 |
| | | | persulfate | | | | | | | | |
| Ex. 2 | WAR(2) | (A) | Ammonium | 5.0 | UV 10 min. | — | 24.1 | 19.5 | 48 | 98 | 86.5 |
| | | | persulfate | | | | | | | | |
| Ex. 3 | WAR(3) | (A) | Ammonium | 5.0 | UV 5 min. | — | 24.5 | 18.7 | 21 | 106 | 86.1 |
| | | | persulfate | | | | | | | | |
| Ex. 4 | WAR(4) | (A) | Sodium | 5.0 | UV 10 min. | — | 25.1 | 18.8 | 47 | 111 | 86.4 |
| | | | persulfate | | | | | | | | |
| Comp. Ex. 1 | WAR (1) for | (A) | Ammonium | 5.0 | Htg*** at 80° C. | — | 31.4 | 8.0 | 0 | 256 | 87.5 |
| | comparison | | persulfate | | for 10 min. | | | | | | |
| Prod. Ex. 2 | BP*(B) | — | — | — | — | — | 33.4 | 7.2 | 0 | — | — |
| Ex. 5 | WAR(5) | (B) | Sodium | 5.0 | UV 10 min. | — | 25.7 | 20.8 | 45 | — | — |
| | | | persulfate | | | | | | | | |
| Comp. Ex. 2 | WAR (2) for | (B) | — | — | UV 10 min. | — | 30.9 | 9.4 | 0 | — | — |
| | comparison | | | | | | | | | | |
| Comp. Ex. 3 | WAR (3) for | (B) | Sodium | 5.0 | Htg at 180° C. | — | 33.6 | 7.2 | 0 | — | — |
| | comparison | | persulfate | | for 60 min. | | | | | | |
| Ex. 6 | WAR(6) | (B) | Sodium | 5.0 | UV 10 min. | Al*⁾: 2 | 23.8 | 19.5 | 102 | — | — |
| | | | persulfate | | | | | | | | |
| Comp. Ex. 4 | WAR (4) for | (B) | — | — | UV 10 min. | Al*⁾: 2 | 33.8 | 7.9 | 0 | — | — |
| | comparison | | | | | | | | | | |
| Comp. Ex. 5 | WAR (5) for | (B) | Sodium | 5.0 | Htg at 180° C. | Al*⁾: 2 | 32.8 | 7.4 | 0 | — | — |
| | comparison | | persulfate | | for 60 min. | | | | | | |
| Prod. Ex. 3 | BP(C) | — | — | — | — | — | 32.8 | 7.2 | 0 | 202 | 93.3 |
| Ex. 7 | WAR(7) | (C) | Sodium | 5.0 | UV 10 min. | — | 26.7 | 21.3 | 40 | 47 | 94.0 |
| | | | persulfate | | | | | | | | |
| Ex. 8 | WAR(8) | (C) | Sodium | 5.0 | UV 10 min. | Al*⁾: 2 | 24.0 | 20.4 | 71 | — | 93.3 |
| | | | persulfate | | | | | | | | |
| Ex. 9 | WAR(9) | (C) | Sodium | 5.0 | UV 10 min. | Al**⁾: 2 | 25.3 | 22.1 | 73 | — | 93.7 |
| | | | persulfate | | | | | | | | |

*Base polymer
**Water absorbent resin
***Heating
*⁾Aqueous 50 wt. % aluminum sulfate,
**⁾Mixed solution of 50 wt % aluminum sulfate and 50% sodium lactate = 5:1
The amounts of the initiator and other additives are indicated with wt. % based on the base polymer.

TABLE 4

| | | | Conditions for surface treatment | | | | | | | | |
|---|---|---|---|---|---|---|---|---|---|---|---|
| | | | Water-soluble | | | | Water absorbing properties | | | | |
| | | | radical | | | | | | SFC | Residual | Solid |
| | | Base | polymerization | Initiator | UV or | Other additive | GV | AAP | (10⁻⁷ · cm³ · | Monomer | content |
| | | polymer | initiator | (wt. %) | heating | (wt. %) | (g/g) | (g/g) | s · g⁻¹) | (ppm) | (%) |
| Ex. 10 | WAR(10) | (A) | Ammonium | 2.5 | UV 10 min. | Ammnoium hydrogen | 24.4 | 19.2 | 71 | 130 | 86.6 |
| | | | persulfate | | | sulfate: 2.5 | | | | | |
| Ex. 11 | WAR(11) | (A) | Ammonium | 2.5 | UV 10 min. | Ammnoium sulfate: 2.5 | 24.1 | 18.1 | 59 | 161 | 86.9 |
| | | | persulfate | | | | | | | | |
| Ex. 12 | WAR(12) | (A) | Ammonium | 2.5 | UV 10 min. | Sodium chloride: 2.5 | 24.9 | 19.9 | 73 | 148 | 85.6 |
| | | | persulfate | | | | | | | | |
| Ex. 13 | WAR(13) | (A) | Ammonium | 2.5 | UV 10 min. | Ammnoium sulfate: 1.65 | 24.3 | 19.2 | 66 | 151 | 86.2 |
| | | | persulfate | | | Sulfuric acid: 1.1 | | | | | |
| Ex. 14 | WAR(14) | (A) | Ammonium | 5.0 | UV 10 min. | Al***⁾: 1.192 | 24.0 | 18.3 | 66 | — | — |
| | | | persulfete | | | | | | | | |
| Ex. 15 | WAR(15) | (A) | Ammonium | 5.0 | UV 10 min. | Polyethylene glycol | 23.8 | 20.3 | 85 | 92 | 86.4 |
| | | | persulfate | | | monomethylether: 0.5 | | | | | |
| Ex. 16 | WAR(16) | (C) | Ammonium | 2.5 | UV 10 min. | — | 26.8 | 19.8 | 26 | 31 | 86.2 |
| | | | persulfate | | | | | | | | |
| Ex. 17 | WAR(17) | (C) | Ammonium | 2.5 | UV 10 min. | Polyethylene glycol | 25.5 | 22.1 | 51 | 43 | 86.6 |
| | | | persulfate | | | monomethylether: 0.5 | | | | | |
| Prod. | BP(D) | — | — | — | — | — | 36.7 | 6.6 | 0 | 105 | 95.4 |
| Ex. 4 | | | | | | | | | | | |
| Ex. 18 | WAR(18) | (D) | Ammonium | 5.0 | UV 10 min. | — | 24.0 | 21.2 | 64 | 28 | 90.8 |
| | | | persulfate | | | | | | | | |
| Ex. 19 | WAR(19) | (D) | Ammonium | 5.0 | UV 10 min. | Polyethylene glycol | 24.6 | 21.5 | 74 | 29 | 89.4 |
| | | | persulfate | | | monomethylether: 0.5 | | | | | |
| Prod. | BP(E) | — | — | — | — | — | 35.0 | 7.9 | 0 | 1321 | 94.8 |
| Ex. 5 | | | | | | | | | | | |
| Ex. 20 | WAR(20) | (E) | Ammonium | 5.0 | UV 10 min. | — | 25.3 | 20.8 | 30 | 738 | 90.1 |
| | | | persulfate | | | | | | | | |
| Ex. 21 | WAR(21) | (E) | Ammonium | 5.0 | UV 10 min. | Polyethylene glycol | 25.0 | 22.2 | 41 | 710 | 90.7 |
| | | | persulfate | | | monomethylether: 0.5 | | | | | |

***⁾Aqueous 50 wt. % aluminium sulfate 14˜18 hydrate solution/propylene glycol/aqueous 60 wt. % sodium lactate solution = 1.0/0.025/0.167 wt. % (based on base polymer)

The surface treatment given to a water absorbent resin with the object of modifying the resin can be effected fully satisfactorily at a reaction temperature approximating normal room temperature and the modified water absorbent resin consequently obtained excels in water absorbing properties and, therefore, is utilized for disposable diapers.

All documents cited in the Detailed Description of the Invention, are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

Each dimension for which a value is defined herein is a technical dimension, which in the context of the present invention is not to be understood literal. Hence, all embodiments having dimensions functionally equivalent to the dimensions stated herein are intended to be covered by the scope of the invention, e.g. a dimension of “40 mm” has to be understood as meaning “about 40 mm”.

What is claimed is:

1. An absorbent member for use in disposable diapers wherein the absorbent member comprises a modified water absorbent resin produced according to the method, which comprises
a) mixing a water absorbent resin and a water-soluble radical polymerization initiator without addition of an ethylenically unsaturated monomer and
b) irradiating the resultant mixture with active energy rays.

2. An absorbent member according to claim 1, wherein said water-soluble radical polymerization initiator is at least one member selected from the group consisting of a persulfate, hydrogen peroxide and water-soluble azo compounds.

3. An absorbent member for use in disposable diapers wherein the absorbent member comprises a modified water absorbent resin produced according to the method, which comprises
a) mixing a water absorbent resin and a heat-degradable radical polymerization initiator without addition of an ethylenically unsaturated monomer and
b) irradiating the resultant mixture with active energy rays.

4. An absorbent member according to claim 3, wherein said heat-degradable radical polymerization initiator is at least one member selected from the group consisting of a persulfate, hydrogen peroxide and azo compounds.

5. An absorbent member according to claim 1, wherein the amount of said radical polymerization initiator to be added to about 100 parts by weight of said water absorbent resin is in the range of about 0.01 to about 20 parts by weight.

6. An absorbent member according to claim 1, wherein said radical polymerization initiator is mixed in the form of an aqueous solution.

7. An absorbent member according to claim 1, wherein the mixture of said water absorbent resin and said radical polymerization initiator is accompanied by further mixture of water in the range of about 1 to about 20 parts by weight based on about 100 parts by weight of the water absorbent resin.

8. An absorbent member according to claim 1, wherein a mixing aid other than water is added at the same time as or prior to the step a).

9. An absorbent member according to claim 8, wherein said mixing aid is at least one water-soluble or water-dispersible compound selected from the group consisting of surfactants, water-soluble polymers, hydrophilic organic solvents, water-soluble inorganic compounds, inorganic acids, inorganic acid salts, organic acids, and organic acid salts.

10. An absorbent member according to claim 8, wherein said mixing aid is at least one water-soluble or water-dispersible compound selected from the group consisting of polyoxyethylene alkyl ethers, polyethylene glycol, water-soluble polyvalent metals, sodium chloride, ammonium hydrogen sulfate, ammonium sulfate, sulfuric acid, and hydrochloric acid.

11. An absorbent member according to claim 8, wherein said mixing aid is added in an amount in the range of about 0.01 to about 40 parts by weight based on about 100 parts by weight of said water absorbent resin.

12. An absorbent member according to claim 1, wherein said water absorbent resin has an acid group and a neutralization ratio (mol % of the neutralized acid group in the whole acid group) in the range of about 50 to about 75 mol %.

13. An absorbent member according to claim 1, wherein said active energy rays are ultraviolet rays.

14. An absorbent member according to claim 1, wherein said water absorbent resin is a powdery resin obtained by polymerizing a monomer having acrylic acid (salt) as a main component.

15. An absorbent member according to claim 1, wherein said water absorbent resin is obtained by producing a water absorbent resin precursor having a low neutralization ratio, and mixing said water absorbent resin precursor with a base.

16. An absorbent member according to claim 1, wherein said water absorbent resin contains particles having diameters in the range of about 150 to about 850 μm in a ratio in the range of about 90 to about 100 wt. %.

17. An absorbent member according to claim 1, wherein the absorbency of physiological saline against pressure of 4.83 kPa of said water absorbent resin subsequent to modification is improved not less than about 1 g/g comparing with the absorbency against pressure of the resin prior to the modification.

18. An absorbent member according to claim 1, wherein the absorbency of physiological saline against pressure of 4.83 kPa of the water absorbent resin subsequent to modification is in the range of about 8 to about 40 g/g.

19. An absorbent member according to claim 1, wherein the saline flow conductivity of the water absorbent resin subsequent to modification is not less than about 10 (10-7·cm3·s·g-1).

20. An absorbent member for use in disposable diapers, wherein the absorbent member comprises a powdery modified water absorbent resin to be obtained by polymerizing monomer components including as a main component acrylic acid (salt), characterized by having
(i) saline flow conductivity of not less than about 40 (10⁻⁷·cm³·s·g⁻¹),
(ii) a solid content of not more than about 95%, and
(iii) a residual monomer content of not more than about 150 ppm.

21. An absorbent member for use in disposable diapers, wherein the absorbent member comprises a powdery modified water absorbent resin according to claim 20, which has free swelling capacity of physiological saline of not less than about 25 g/g.

22. An absorbent member for use in disposable diapers, wherein the absorbent member comprises a powdery modified water absorbent resin according to claim 20, which has absorbency of physiological saline against pressure of 4.83 kPa of not less than about 22 g/g.

23. An absorbent member for use in disposable diapers wherein the absorbent member comprises a modified water absorbent resin produced according to the method, which comprises
a) mixing a water absorbent resin and a persulfate without addition of an ethylenically unsaturated monomer,
b) adding a mixing aid other than water at the same time as or prior to the step a), and
c) irradiating the resultant mixture with active energy rays.

24. An absorbent member for use in disposable diapers wherein the absorbent member comprises a modified water absorbent resin produced according to the method, which comprises
a) mixing a water absorbent resin and a persulfate without addition of an ethylenically unsaturated monomer, and
b) irradiating the resultant mixture with active energy rays,
wherein said water absorbent resin has an acid group and a neutralization ratio (mol % of the neutralized acid group in the whole acid group) in the range of about 50 to about 75 mol %.

25. An absorbent member for use in disposable diapers wherein the absorbent member comprises a modified water absorbent resin produced according to the method, which comprises
a) mixing a water absorbent resin and a persulfate without addition of an ethylenically unsaturated monomer,
b) adding a mixing aid other than water at the same time as or prior to the step a), and
c) irradiating the resultant mixture with active energy rays,
wherein said water absorbent resin has an acid group and a neutralization ratio (mol % of the neutralized acid group in the whole acid group) in the range of about 50 to about 75 mol %.
